(19) United States
(12) Patent Application Publication
(10) Pub. No.: US 2004/0117282 A1
(43) Pub. Date: Jun. 17, 2004

(54) System and method for creating and managing new and existing financial instruments

(76) Inventors: Richard J. Green, Woodbury, NY (US); Yonathan Epelbaum, New York, NY (US); James G.M. Gatheral, New York, NY (US); Jining Han, New Providence, NJ (US); Bradley Kurtzman, New York, NY (US); Olga Lubovitsky, Princeton, NJ (US)

Correspondence Address: OPPEDAHL AND LARSON LLP, P O BOX 5068, DILLON, CO, 80435-5068, US

(21) Appl. No.: 10/467,028

(22) PCT Filed: Aug. 12, 2002
(86) PCT No.: PCT/US02/25696

(51) Int. Cl. G06F 17/60

(52) U.S. Cl. 705/35

(57) ABSTRACT

It is an object of the invention to provide systems and methods for creating or developing, issuing, and servicing or maintaining convertible or exchangeable financial instruments. These convertible or exchangeable financial instruments are created by a building block approach, whereby new financial instruments can be generated and evaluated prior to issuance. In other embodiments, a user will be able to employ the systems and methods for origination, testing, issuance or sale, marketing, trading, hedging, risk management and regulation of convertible or exchangeable financial instruments.

### CROSS REFERENCE TO RELATED APPLICATION

This claims the benefit of U.S. Provisional Patent Application Nos. 60/311,516 and 60/311,574, filed Aug. 10, 2001, which are hereby incorporated by reference in their entireties.

### BACKGROUND OF THE INVENTION

This invention relates to systems and methods for creating, issuing, servicing, or maintaining convertible and exchangeable financial instruments (e.g., debt instruments, preferred instruments, trust preferred instruments, warrants, certain insurance contracts, and suitable derivatives thereof, or any security backed by any of the above) and computer-based user interfaces therefor.

A convertible financial instrument, which may be converted in to something of value (e.g., common stock), may be referenced throughout this application. The scope of this invention also includes exchangeable financial instruments, which may be exchanged for something of value.

Systems and methods utilized for origination, sales, marketing, trading, hedging, risk management, and regulatory purposes often require major enhancements to adapt to innovations in financial instruments. Currently, when a new financial instrument is brought to market, a new model must be generated and existing software may require enhancements or revisions. Generation of a new model and revisions of software are often costly and not practical because they result in delay between inventing a new financial instrument and bringing the financial instrument to market.

The ability to efficiently bring innovative financial instruments to market is necessary to remain competitive in the sale of financial instruments. A system and method for creating and testing new financial instruments that provides a user with the flexibility to customize financial instruments would be advantageous for two reasons. First, the high cost of adapting systems and methods for origination, testing, issuance or sale, marketing, trading, hedging, risk management and regulation of innovative financial instruments makes the creation of new financial instruments cost prohibitive. Second, because time is of the essence, the traditional delays associated with creating new financial instruments and associated with adapting systems and methods to new financial instruments, which exist between the creation of new financial instruments and actually bringing the new financial instrument to market, render the existing models or calculators and associated systems impractical for use in bringing new financial instruments to the market.

It would be desirable and advantageous to have the ability to create and test innovative financial instruments, without the traditional delays and associated costs. It would also be desirable to provide a system and method to allow users to experiment with new product ideas, by allowing the user an opportunity to evaluate the financial instrument prior to issuance.

### SUMMARY OF THE INVENTION

It is an object of the invention to provide the ability to create and test innovative financial instruments, without the traditional delays and associated costs, and to provide a system and method to allow users to experiment with new product ideas, by allowing them an opportunity to evaluate the financial instrument prior to issuance.

The present invention provides systems and methods for creating (including testing and evaluating), issuing (including offering and selling, and servicing or maintaining convertible or exchangeable financial instruments. These financial instruments are created by a “building block approach”, which allows a user to build a financial instrument by selecting specific objects and features, and then providing the specific inputs for each selected feature. The invention further provides a user with the ability to experiment by selecting and re-selecting desired objects and/or features of a new financial instruments. Specifically the model/calculator and system of this invention allow flexibility by providing a user the opportunity to select the desired objects and state the features of each desired object. The benefit of the flexible model/calculator and associated system, of this invention, is that a user can simulate, generate and evaluate new financial instruments without creating a new model/computer and system for each new financial instrument. This invention allows capital markets to experiment with new product ideas in an affordable and time-effective manner and minimize time period between the creation of a new financial instrument and the marketing of the new financial instrument.

In some embodiments, a user preferably will be able to use the systems and methods for the origination, testing, issuance or sale, marketing, trading, hedging, risk management and regulation of convertible or exchangeable financial instruments.

In some embodiments, the convertible or exchangeable financial instruments may be based on, for example, long-term zero coupon notes (e.g., those sold by Merrill Lynch and Company, Inc. under the trademark Liquid Yield Option Notes or LYONs), cash pay or partial cash pay convertible or exchangeable bonds issued at a discount, debt instruments, preferred instruments, trust preferred instruments, warrants, certain insurance contracts, suitable derivatives thereof, or any security backed by any of the above.

### BRIEF DESCRIPTION OF THE DRAWINGS

The above and other objects and advantages of the invention will be apparent upon consideration of the following detailed description, taken in conjunction with the accompanying drawings, in which like reference characters refer to like parts throughout, and in which:

FIG. 1 is illustrative of the information flow for: (1) developing and testing a financial instrument, (2) issuing a financial instrument, and (3) servicing and maintaining a financial instrument.

FIG. 2 illustrates some preferred embodiments of the method according to the invention to develop or create a convertible or exchangeable instrument financial instrument in accordance with the present invention;

FIG. 3 illustrates some preferred embodiments of the method according to the invention to issue or pricing a convertible or exchangeable financial instrument in accordance with the present invention;

FIG. 4 illustrates some preferred embodiments of the method according to the invention to service or maintain convertible or exchangeable financial instrument in accordance with the present invention;

FIG. 5 shows preferred screen shots and flow of information in a system where a user selected the Redemption Object as illustrated at step 202 in FIG. 2, step 304 in FIG. 3, or step 404 in FIG. 4;

FIG. 6 shows preferred screen shots and flow of information in a system where a user selected the Cash Flow Object as illustrated at step 202 in FIG. 2, step 304 in FIG. 3, or step 404 in FIG. 4;

FIG. 7 shows preferred screen shots and flow of information in a system where a user selected the Model Parameters Object as illustrated at step 202 in FIG. 2, step 304 in FIG. 3, or step 404 in FIG. 4;

FIG. 8 shows preferred screen shots and flow of information in a system where a user selected the Conversion Object as illustrated at step 202 in FIG. 2, step 304 in FIG. 3, or step 404 in FIG. 4;

FIG. 9 shows preferred screen shots and flow of information in a system where a user selected the Holder's Put Object as illustrated at step 202 in FIG. 2, step 304 in FIG. 3, or step 404 in FIG. 4;

FIG. 10 shows preferred screen shots and flow of information in a system where a user selected the Issuer Call Object as illustrated at step 202 in FIG. 2, step 304 in FIG. 3, or step 404 in FIG. 4;

FIG. 11 shows preferred screen shots and flow of information in a system where a user selected the Issue Terms Object as illustrated at step 202 in FIG. 2, step 304 in FIG. 3, or step 404 in FIG. 4;

FIG. 12 shows preferred screen shots and flow of information in a system where a user selected the Bankruptcy Object as illustrated at step 202 in FIG. 2, step 304 in FIG. 3, or step 404 in FIG. 4;

FIG. 13 shows preferred screen shots and flow of information in a system where a user selected the Accretion Object as illustrated at step 202 in FIG. 2, step 304 in FIG. 3, or step 404 in FIG. 4;

FIG. 14 shows preferred screen shots and flow of information in a system where a user selected the Contingent Payment (“CoPa”) Object as illustrated at step 202 in FIG. 2, step 304 in FIG. 3, or step 404 in FIG. 4;

FIG. 15 shows preferred screen shots and flow of information in a system where a user selected the Contingent Conversion (“CoCo”) Object as illustrated at step 202 in FIG. 2, step 304 in FIG. 3, or step 404 in FIG. 4;

FIG. 16 is a cross-sectional view of a magnetic data storage medium encoded with a set of machine-executable instructions for performing the method in accordance with the present invention; and

FIG. 17 is a cross-sectional view of an optically readable data storage medium encoded with a set of machine executable instructions for performing the method in accordance with the present invention.

### DETAILED DESCRIPTION OF THE INVENTION

The present invention allows users to not only create and test innovative financial instruments, without having the traditional delays and associated costs, but also provides a system and method that allows users to evaluate the financial instrument prior to issuance.

In accordance with the present invention, a model/calculator and associated system allows capital markets to experiment with new product ideas in a cost effective and timely manner. More particularly, the delay between creation of a new financial instrument and bringing the new financial instrument to market is minimized to make the creation of new convertible or exchangeable financial instruments feasible. For example, in addition to allowing creation of completely new financial instruments, the model/calculator and associated system of this invention allow a user to add additional objects and/or features to pre-existing financial instrument (i.e., financial instruments are “flexible” or “extendable”) in order to create a new financial instrument.

The generation of “flexible” or “extendable” financial instruments is accomplished by representing all elements of convertible and exchangeable financial instruments in a generic form—i.e., as objects or features. By representing all objects and features in a generic form a user may use a “building block approach” to construct and test new financial instruments. This building block approach provides a user with the ability to build a financial instrument by selecting any number and/or combination of objects, and then selecting the specific features for each object selected.

The building block approach also allows a user to re-select or de-select specific features. In some embodiments, a user may enter specific inputs, in order to create a customized convertible financial instrument. Additionally, some embodiments may provide a database and rules engine containing all objects of a new financial instrument, allowing for evaluation and continued management of a new financial instrument in a time-effective and cost-efficient manner. A database design and maintenance application preferably will use a building block approach as described in the model/calculator and interface system, allowing extendability to the financial instrument and allowing for a timely introduction of a new financial instrument into the market.

In some embodiments of this invention a model/calculator and interface preferably will allow an issuer to create a new type of convertible or exchangeable financial instrument. In some embodiments, the application and model/calculator are easily extendable and may provide convertible and exchangeable features as an object. For example, a Conversion object may be selected and the input information may allow construction of a conversion payoff as a function of underlying stock price and time. Some examples of additional objects for selection and input include: Redemption, Issuer Call Terms, Cash Flow, Credit, Model Parameters, Holder's Put, Bankruptcy, Accretion, Contingent Payment (“CoPa”), Contingent Conversion (“CoCo”), and Issue Terms. Bankruptcy protection is similarly represented in a generic form as a Bankruptcy object. In some embodiments, a bankruptcy object may provide inputs related to bankruptcy protection, cash flow protection, and principal protection. The inventor of a financial instrument may use a building block approach to construct and test new financial instruments by selecting one or more objects, and entering specific inputs for each selected object.

In some embodiments, the model/calculator and system are capable of processing large numbers of model/calculator inputs and combinations of objects and inputs using a spreadsheet interface program. In this system, objects are used to compartmentalize inputs. Examples of objects include: Redemption (i.e., expiration and return of principal), Cash Flow (i.e., coupons or dividends), Conversion (i.e., Holder's option to convert or exchange the instrument into an underlying asset), Issuer Call Terms (i.e., Issuer's option for an early redemption), Holder's Put (i.e., Holder's option for an early redemption), Credit, Issue Terms, Bankruptcy, Accretion, Contingent Payment (“CoPa”), Contingent Conversion (“CoCo”), and Model Parameters. Additionally a Call Delay and a Convertible Bond Option (“CBO”) object may be selected. Each object is run as a separate function through a Risk Analysis and Management system.

Also, two adaptable model/calculator applications may be available. One application is a simple application, which does not require identification of an underlying object. A second more advanced application is identical to the simple application, but requires a user designates at least one underlying object. Some examples of a underlying object include a stock, an index or a basket of stocks.

Some examples of types of data that may be calculated by the model/calculator for future use by the model/calculator include: accrued interest, cash flows, accreted value, call price and provisional trigger, put price, convertible bond option strike and reference strike data.

In some embodiments, the same application and model/calculator are used for convertible bond options and convertible or exchangeable instruments. More specifically, convertible or exchangeable bond options and convertible or exchangeable instruments preferably will be calculated simultaneously and both sets of results may be displayed at the same time. For example, the convertible or exchangeable bond object simply passes as an argument to the convertible or exchangeable model/calculator along with the other convertible or exchangeable model/calculator inputs.

In some embodiments, short cuts may be used to create objects. For example, number of shares may be used in place of a conversion object or maturity date may be used in place of a redemption object or repurchase spread may be used in place of a convertible or exchangeable bond option object.

In some embodiments, the objects may allow a user the flexibility of creating sample spread sheets for financial instruments.

In some embodiments, a user is allowed to display only relevant information with respect to a new financial instrument.

The convertible or exchangeable model/calculator may also be used to cut and paste from example spreadsheets of detailed quantitative analysis.

In some embodiments, a database and maintenance application, which preferably will contain all objects, allows for evaluation and continued management of a new financial instrument in a time-effective and cost-efficient manner. The database design and maintenance application uses the same building block approach described in the model/calculator and interface system. This type of application allows a pre-existing financial instrument the flexibility to be modified through the addition of new objects and/or re-selection of features without the need to create a whole new model. The ability to create and test new financial instruments by simply modifying an already financial instrument allows for a timely introduction of a new financial instrument into the market.

In some embodiments, a rules engine maintains objects and inputs of newly created convertible or exchangeable financial instruments, allowing a user an opportunity to evaluate and manage a new financial instrument in the after market. In some embodiments, a rules engine utilizes financial instrument features from several sources (i.e., internal or external financial sources) that may be normalized into a generic representation and analyzed to facilitate the ongoing maintenance (i.e., quality control and/or check of regular schedules) of the aforementioned database. This ability to conduct continued servicing provides a further advantage to a user by allowing the user to re-call, from a rules engine, an already created and issued financial instrument and adjust the terms of the financial instrument to include the desired inputs for each selected object and/or feature.

In accordance with some embodiments of this invention, a user may select the results he or she may want to calculate and display by using a result object. A result object allows customization of the output data. More particularly, a true or false entry is selected from a pull-down menu for specific result outputs. Some result outputs include: Value, Raw Data, Raw Gamma, Pty Delta, Pty Gamma, Theta, “Vega” —the difference in value of a +1% shift in volatility, “Rho” —the difference in value for a +10 bp shift in the yield curve, “Credit Risk” —difference in value for a +10 bp shift in the credit curve, Convertible Bond Strike, Calibrated Volatility, “Straight Bond Value” —the value of a CVT without the right to convert into stock, but with issuer call and puts taken into account, and Risk “Neutral Average Life” —the probability weighted duration of the CVT taking into account maturity, issuer call, put and conversion. Additionally, in some embodiments, Convertible Bond Strike or “asset swap bond floor” are only returned when convertible or exchangeable bond option terms are specified, and when the Calibrated Volatility is TRUE, the input volatility is risk free and volatility is downward adjusted to compensate for credit. The Calibrated Volatility result is only returned when designated as TRUE.

Additionally, a user may request that results be displayed in a specific format. For example, a user may designate column labels and an optional third column to display the Convertible Bond Option (“CBO”) using a TRUE/FALSE pull-down menu. Generally, selection of the TRUE pull-down preferably will display the entry for that particular result object, and a selection of the FALSE pull-down will result in no display for that particular result object. Results may be displayed in a one, two or three column format. For example, when the pull-down for “Label Column” is marked as TRUE, the first column provides labels corresponding to the CVT data displayed in column two. When the pull-down for “CBO Column” is marked as TRUE, the CBO results appear in a third column, however, when the “CBO Column” is marked as FALSE, the CBO results may appear in the second column along with the CVT results.

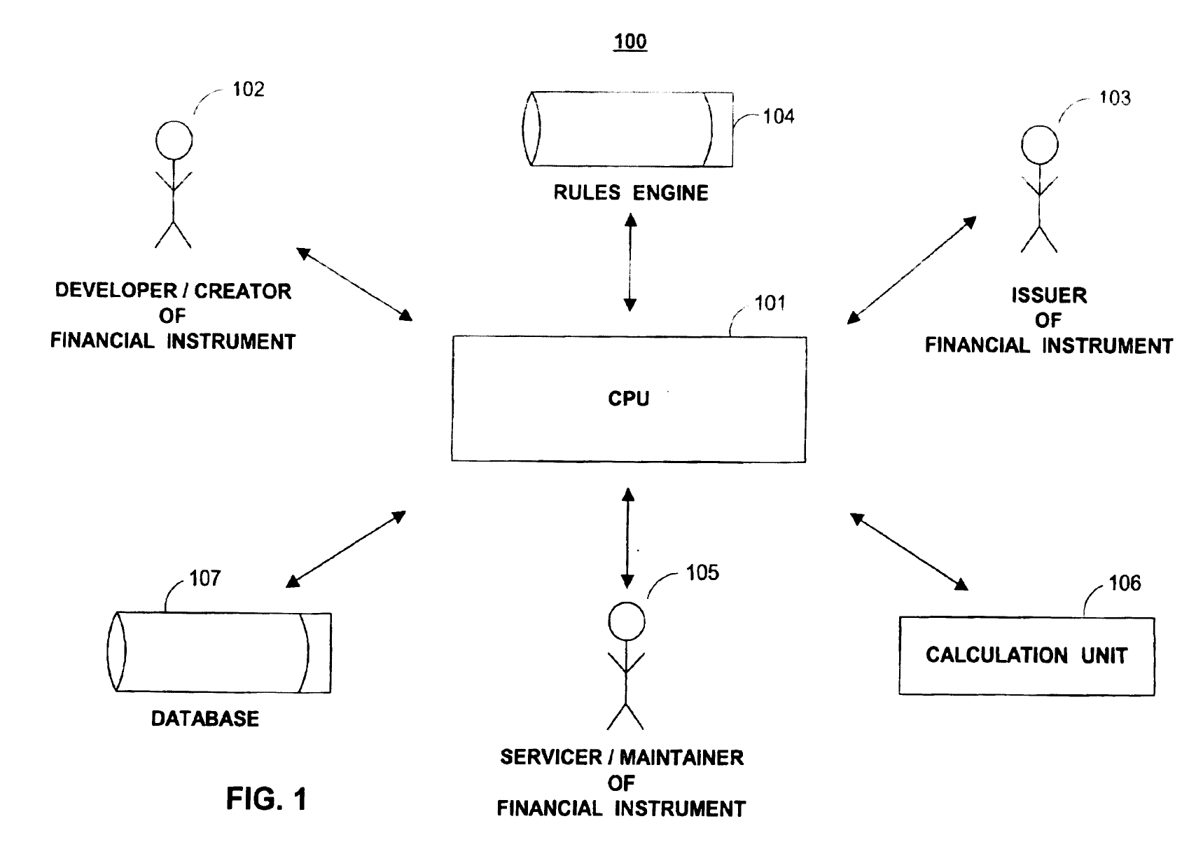

Systems and methods for creating, simulating, testing, generating, servicing and/or maintaining innovative financial instruments in accordance with the present invention may be described in conjunction with FIGS. 1-13.

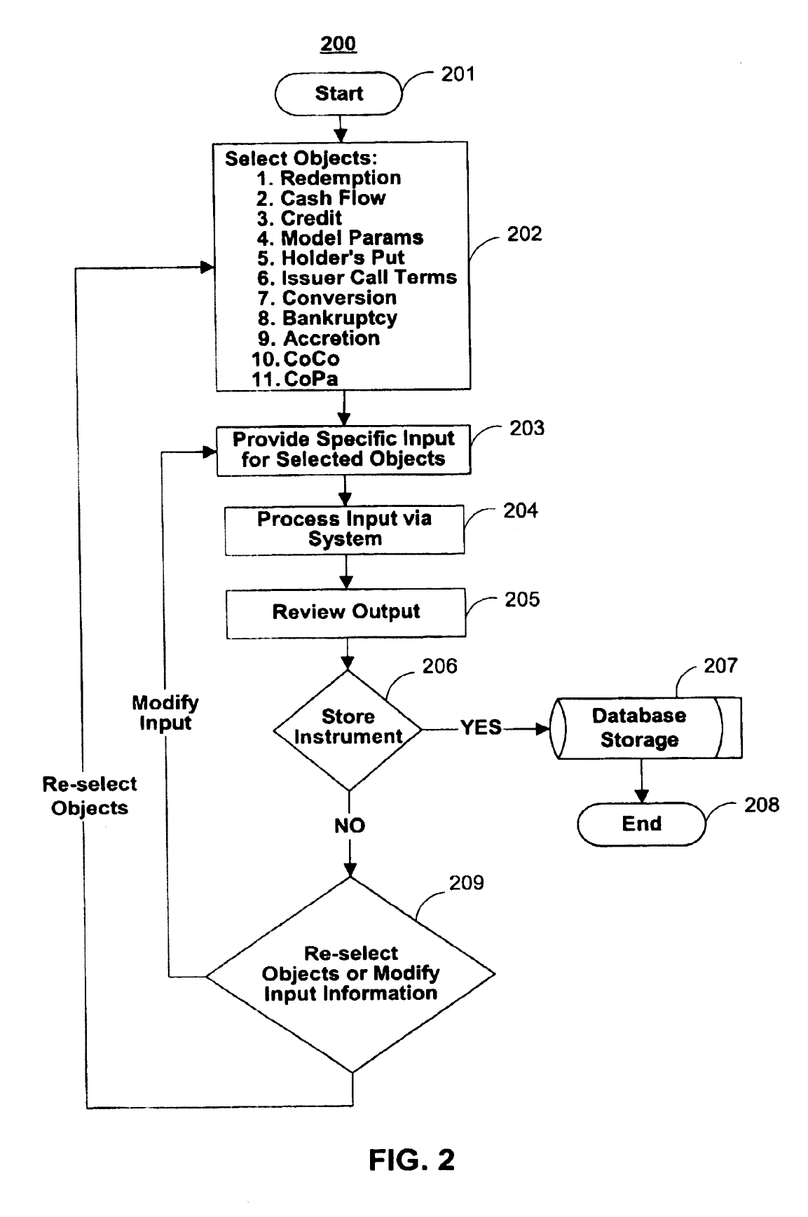

FIG. 1 is illustrative of the information flow in a system 100 for creating, simulating and testing a financial instrument by a user 102, issuing a financial instrument by a user 103, and servicing and maintaining a financial instrument by a user 105. The flow of information begins with a user 102, 103 or 105 selecting the desired inputs, via systems 200, 300, or 400 (as illustrated in FIGS. 2-4), and sending input information to the central processing unit (“CPU”) 101 for processing. Processing of input is accomplished at the calculation unit 106. Calculated results are returned to the CPU for further processing or storage of the financial instrument or output. Following completion of processing by the CPU 101, the structure of the financial instrument or output may be stored for later retrieval. Upon a decision to store the structure of the financial instrument or output, a user may store the information (i.e., structure or output of financial instrument) financial instrument on a database 107 or at the rules engine 104. Upon a decision to further process stored input or modify a financial instrument, the stored input or financial instrument may be retrieved from the database 107 or rules engine 104.

FIG. 2 shows some preferred embodiments of the method according to the invention to create or simulate a convertible or exchangeable financial instrument. The method starts at step 201 where a user, or other entity, creates or simulates a convertible or exchangeable financial instrument. In doing so, a user preferably will begin by opening a spread sheet at step 201. The method then proceeds to step 202, where a user selects various input objects from a list of selected objects. Selected objects may include: Redemption, Cash Flow, Credit, Model Parameters, Holder's Put, Issuer Call Terms, Conversion, Bankruptcy, Accretion, Contingent Payment, Contingent Conversion, or Issue Terms. Next, at step 203, the issuer provides specific inputs for each of the selected objects. The input may be entered, e.g., using an alpha-numeric keyboard. The method then proceeds to step 204, where the input is processed via the system. Next, at step 205, the issuer has the opportunity to review the data generated by the new convertible or exchangeable financial instrument as Output. Following review of the Output at step 205, the issuer has the option at step 206 to store the financial instrument in a database at 207 or re-select objects or modify inputs at step 209. If the issuer elects to store the financial instrument the financial instrument may be stored in a computer database at step 207. Following storage of the financial instrument at step 207, the program completes at step 208. In the event that a user declines to store the financial instrument at step 206, the issuer may elect to re-select objects or modify inputs at step 209. Upon a decision to re-select objects at step 209, the issuer re-enters the above-described system at step 202 and proceeds through steps 203 to 206 with respect to the re-select objects, which were entered in step 202. Upon a decision to modify inputs at step 209, the issuer re-enters the above-described system at step 203 and proceeds through steps 204 to 206 with respect to the modified inputs, which were entered in step 203.

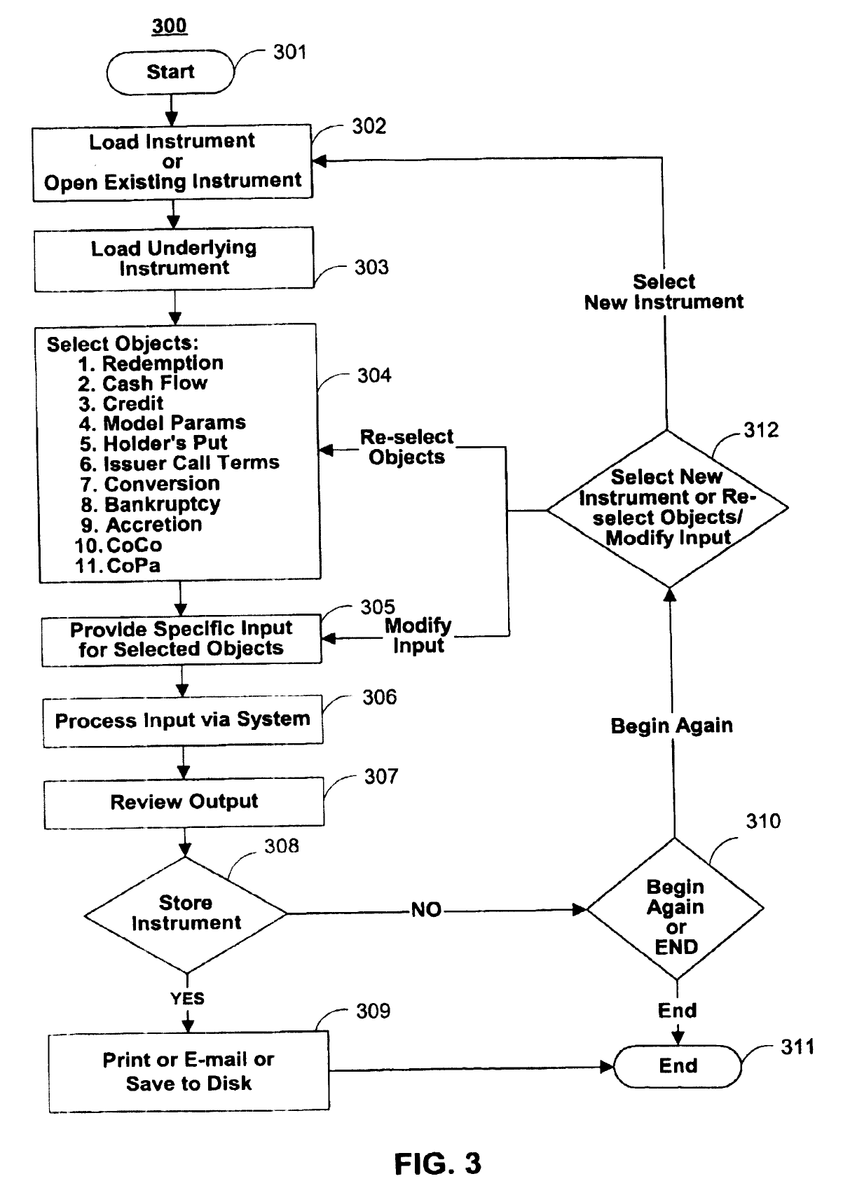

FIG. 3 shows some preferred embodiments of the method according to the invention to issue a convertible or exchangeable financial instrument. The method starts at step 301 where a user, or other entity, decides to issue a convertible or exchangeable financial instrument. In doing so, a user may begin by opening a spread sheet at step 301. The method then proceeds to step 302, where a user may elect to load a financial instrument or open an existing financial instrument. Next, at step 303, the issuer may elect to load an underlying financial instrument. A user then proceeds to step 304, where a user selects various input objects from a list of selected objects. Selected objects may include: Redemption, Cash Flow, Credit, Model Parameters, Holder's Put, Issuer Call Terms, Conversion, Bankruptcy, Accretion, Contingent Payment, Contingent Conversion, or Issue Terms. Next, at step 305, the issuer provides specific inputs for each of the selected objects. The input may be entered, e.g., using an alpha-numeric keyboard. The method proceeds to step 306 to where the input is processed via the system. At step 307, the issuer has the opportunity to review the output of the new convertible or exchangeable financial instrument. Following review of the output 307, the issuer has the option at step 308 to store the financial instrument. If the issuer elects to store the instrument at step 308, a user proceeds to step 309. At step 309, the stored instrument may be printed as a hard copy, stored via e-mail or stored to a disk (e.g., floppy disk or hard drive). In the event that a user would like to make additional changes to the financial instrument, before saving the financial instrument, the issuer proceeds to step 310, where a user may begin again or end the program. Upon selection of begin again at step 310, the issuer proceeds to step 312, which allows a user to select a new financial instrument or re-select objects or modify input. Upon a decision to select a new financial instrument at step 312, a user re-enters the above-described system at step 302 and proceeds through steps 303 to 308 with respect to the new financial instrument, which was selected in step 302. Upon a decision to re-select objects at step 312, a user re-enters the above-described system at step 304 and proceeds through steps 305 to 308 with respect to the re-select objects, which were selected in step 304. Upon selection of modify input at step 312, a user re-enters the above-detailed system at step 305 and proceeds through steps 306 to 308 employing the modified input, which was entered in step 305. Upon selection of end at step 310, the program completes at 311.

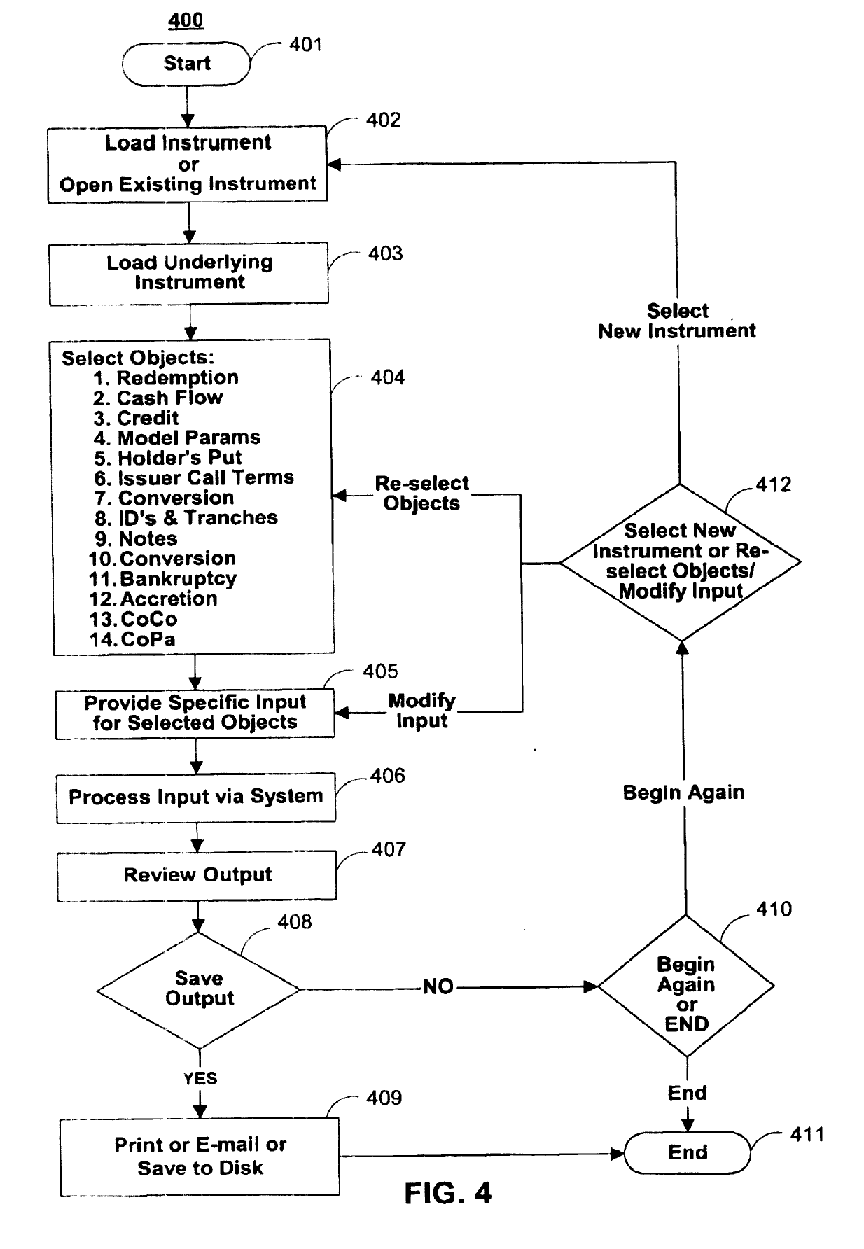

FIG. 4 shows some preferred embodiments of the method according to the invention to service or maintain a convertible or exchangeable financial instrument. The method starts at step 401 where a user, or other entity, decides to service or maintain a convertible or exchangeable financial instrument. In doing so, a user may begin by opening a spread sheet at step 401. The method then proceeds to step 402, where a user may elect to load a financial instrument or open an existing financial instrument. Next, at step 403, the issuer may elect to load an underlying financial instrument. A user then proceeds to step 404, where a user selects various input objects from a list of selected objects. Selected objects may include: Redemption, Cash Flow, Credit, Model Parameters, Holder's Put, Issuer Terms, Conversion, ID's & Tranches, Notes, Bankruptcy, Accretion, Contingent Payment, and Contingent Conversion. Next, at step 405, the issuer provides specific inputs for each of the selected objects. The input may be entered using an alpha-numeric keyboard. The method proceeds to step 406 to where the input is processed via the system. At step 407, the user has the opportunity to review the Output of the serviced or maintained financial instrument. Following review of the Output at step 407, the issuer has the option at step 408 to store the Output of the serviced or maintained financial instrument. If the issuer elects to store the Output at step 408, the user proceeds to step 409. At step 409, the Output of the serviced or maintained financial instrument may be printed as a hard copy, stored via e-mail or stored to a disk (e.g., floppy disk or hard drive). In the event that a user declines to store the Output at step 408, the issuer proceeds to step 410, where a user may begin again or end the program. Upon selection at step 410 of begin again, the issuer proceeds to step 412, which allows a user to select a new financial instrument or re-select objects or modify input. Upon a decision to select a new financial instrument at step 412, a user re-enters the above-described system at step 402 and proceeds through steps 403 to 408 with respect to the new financial instrument, which was selected in step 402. Upon a decision to re-select objects at step 412, a user re-enters the above-described system at step 404 and proceeds through steps 405 to 408 with respect to the re-select objects, which were selected in step 404. Upon selection of modify input at step 412, a user re-enters the above-described system at step 405 and proceeds through steps 406 to 408 with respect to the modified input, which was entered in step 405. Upon selection of end at step 410, the program completes at 411.

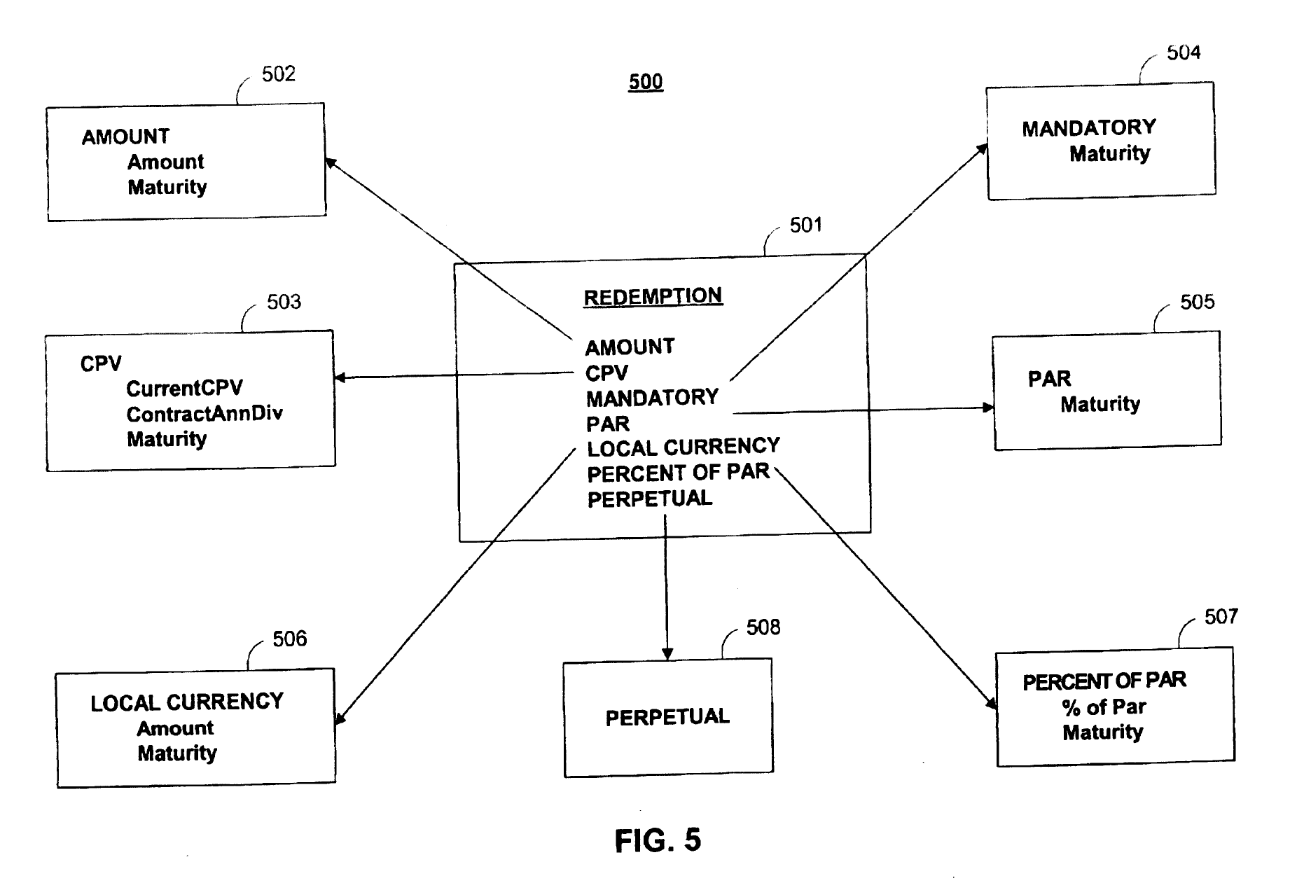

FIG. 5 shows preferred screen shots and flow of information in a system 500 for the Redemption Object of this invention. A creator who creates, simulates or generates a financial instrument with a Redemption object at step 202 in FIG. 2, an issuer issuing a financial instrument with a Redemption Object at step 304 in FIG. 3, or a user who service or maintains a financial instrument using a Redemption Object at step 404 in FIG. 4, may select from a list of Redemption features at step 501. Redemption features may include: Amount 502, Contingent Principal Value (“CPV”) 503, Mandatory 504, Par 505, Local Currency 506, Percent of Par 507 or Perpetual 508. Upon selection of Amount 502 a user preferably will be provided with a list of appropriate inputs corresponding to the Amount. The list of Amount 502 inputs may include amount and maturity date. Upon selection of CPV 503 a user preferably will be provided with a list of appropriate inputs corresponding to the CPV. The list of CPV 503 inputs may include: Current CPV, Contract Annual Dividends and Maturity. Upon selection of Mandatory 504 a user preferably will be provided with a list of appropriate inputs corresponding to the Mandatory. The list of Mandatory 504 inputs may include: Maturity. Upon selection of Par 505 a user preferably will be provided with a list of appropriate inputs corresponding to the Par. The list of Par 505 inputs may include: Maturity. Upon selection of Local Currency 506 a user preferably will be provided with a list of appropriate inputs corresponding to the Local Currency. The list of Local Currency 506 inputs may include: Amount and Maturity. Upon selection of Percent of Par 507 a user preferably will be provided with a list of appropriate inputs corresponding to the Percent of Par. The list of Percent of Par 507 inputs may include: % of Par and Maturity. The actual Redemption amount input may be entered using an input device including an alpha-numerical key pad. Alternatively a drop-down menu may present input options for a user to select a desired input.

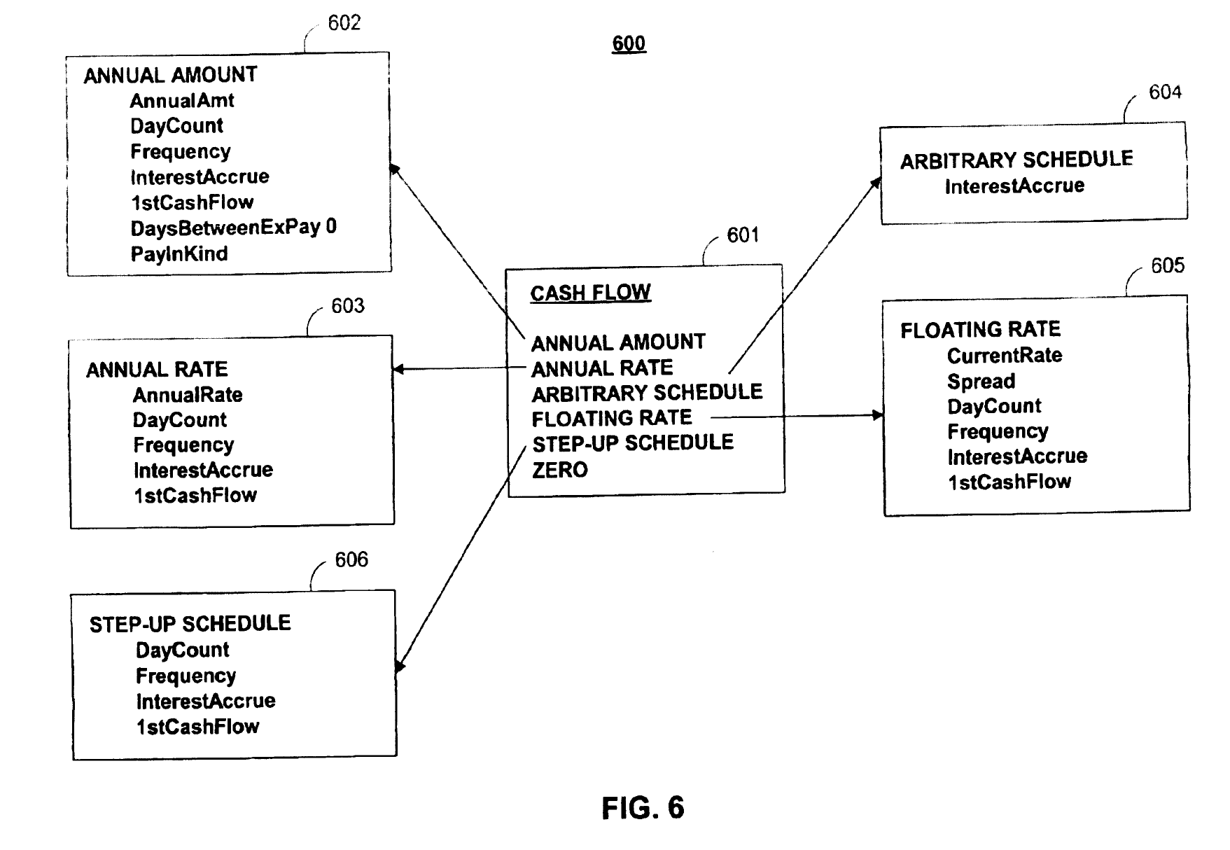

FIG. 6 shows preferred screen shots and flow of information in a system 600 for the Cash Flow Object of this invention. A creator who creates, simulates or generates a financial instrument with a Cash Flow Object, at step 202 in FIG. 2, an issuer who issues a financial instrument containing a Cash Flow Object at step 304 in FIG. 3, or a user who service or maintains a financial instrument using a Cash Flow Object at step 404 in FIG. 4, may select from a list of Cash Flow features at step 601. Cash Flow features may include: Annual Amount 602, Annual Rate 603, Arbitrary Schedule 604, Floating Rate 605, Step-Up Schedule 606, and Zero 607. Upon selection of Annual Amount a user preferably will be provided with a list of appropriate inputs corresponding to the Annual Amount at step 602. The list of Annual Amount inputs, at step 602, may include: Annual Amount, Day Count, Frequency, Interest Accrued, 1stCashFlow, and Pay In Kind. Upon selection of Annual Rate at step 603 a user preferably will be provided with a list of appropriate inputs corresponding to the Annual Rate. The list of Annual Rate inputs may include: Annual Rate, Day Count, Frequency, Interest Accrued, and 1stCashFlow. Upon selection of Arbitrary Schedule at step 604 a user preferably will be provided with a list of appropriate inputs corresponding to the Arbitrary Schedule. At step 604, the list of Arbitrary Schedule inputs may include: Interest Accrued. Upon selection of Floating Rate at step 605, the user preferably is provided with a list of appropriate inputs corresponding to the Floating Rate. The list of Floating Rate inputs, at step 605 may include: Current Rate, Spread, Day Count, Frequency, Interest Accrued, and 1stCashFlow. Upon selection of Step-Up Schedule 606 a user preferably will be provided with a list of appropriate inputs corresponding to the Step-Up Schedule. At step 606 the list of Step-Up Schedule inputs may include: Day Count, Frequency, Interest Accrued, and 1^{st} Cash Flow. The actual Cash Flow input values may be entered using an input device including an alpha-numerical key pad. Alternatively a drop-down menu may present input options for a user to select a desired input.

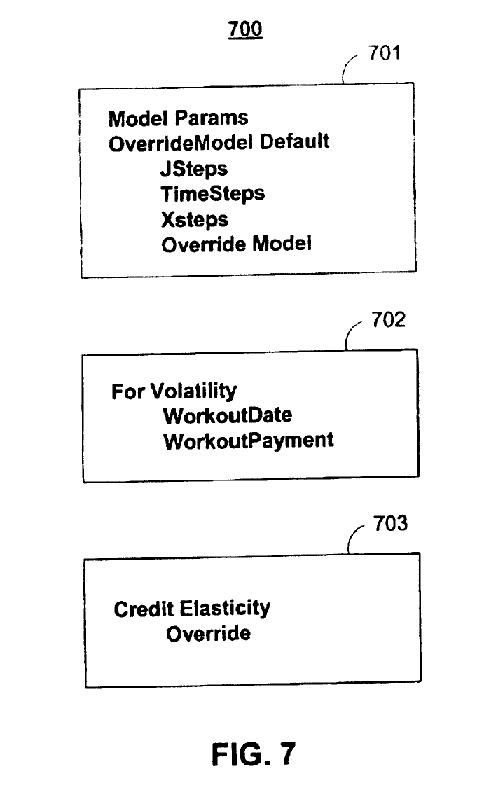

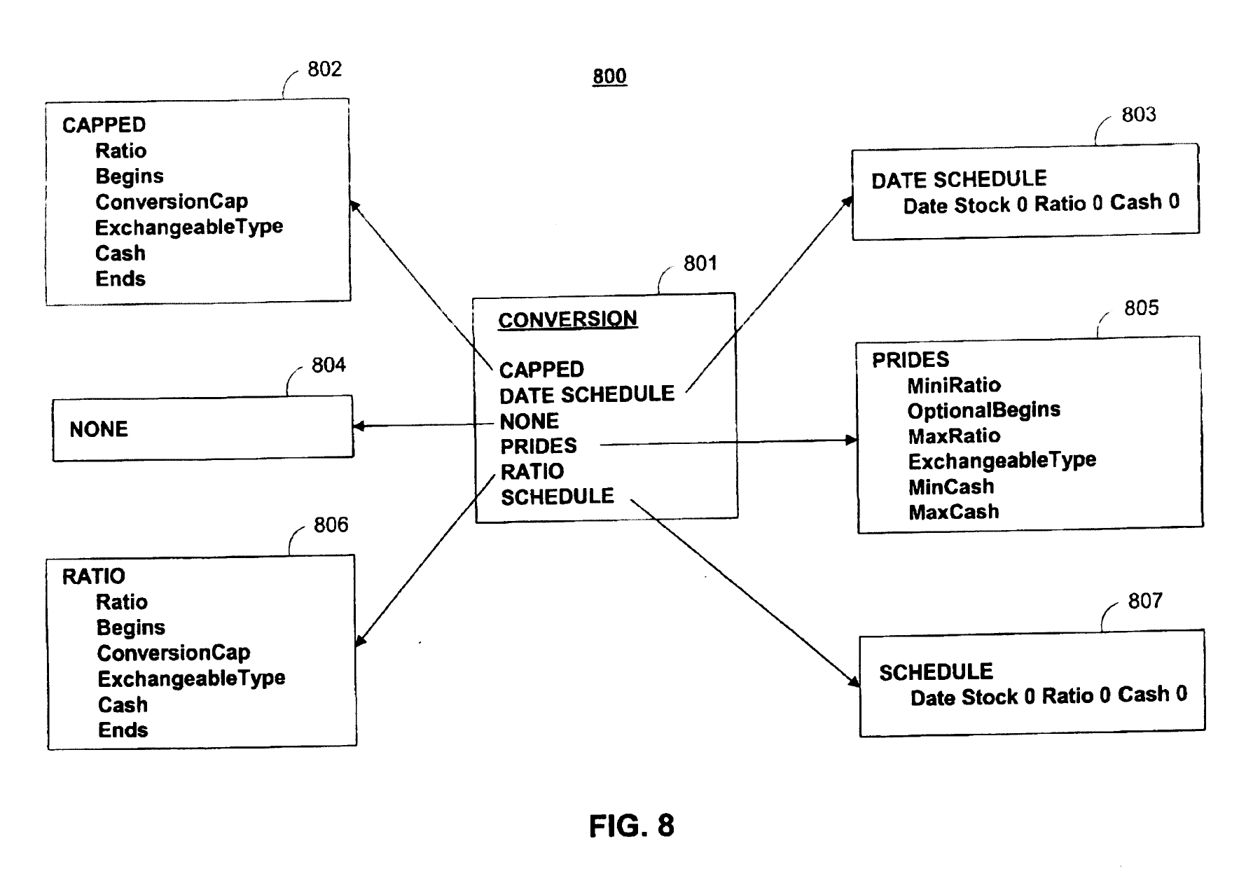

FIG. 7 shows preferred screen shots and flow of information in a system 700 for the Model Parameters Object of this invention. A creator who creates, simulates or generates a financial instrument containing a Model Parameters Object at step 202 in FIG. 2, an issuer who issues a financial instrument containing a Model Parameters Object at step 304 in FIG. 3, or a user who service or maintains a financial instrument using a Model Parameters Object at step 404 in FIG. 4, may select from various Model Parameters inputs 700. Model Parameters inputs may include: Override Model Default 701, For Volatility 702, and Credit Elasticity 703. Upon selection of Override Model Default at step 701, the user preferably is provided with a list of appropriate inputs corresponding to the Override Model Default. The list of Override Model Default inputs includes: J steps, Time Steps, X steps and Override Model. Upon selection of For Volatility, at step 702, the user preferably is provided with a list of appropriate inputs corresponding to the For Volatility. The list of For Volatility inputs may include: Workout Date and workout Payment. Upon selection of Credit Elasticity, at step 703, the user preferably is provided with a list of appropriate inputs corresponding to the Credit Elasticity. The list of Credit Elasticity inputs includes: Override. The actual Model Parameters input may be entered using an input device including an alpha-numerical key pad. Alternatively a drop-down menu may present input options for a user to select a desired input.

FIG. 8 shows preferred screen shots and flow of information in a system 800 for the Conversion Object of this invention. A creator who creates, simulates or generates a financial instrument with a Conversion Object at step 202 in FIG. 2, an issuer who issues a financial instrument with a Conversion Object at step 304 in FIG. 3, or a user who services or maintains a financial instrument using a Conversion Object at step 404 in FIG. 4, may select from a list of Conversion features, at step 801. Conversion inputs may include: Capped, Date Schedule, None, Types of Instrument (e.g., PRIDES, PRIZES, etc.), Ratio, and Schedule. Upon selection of Capped, at step 802, the user preferably is provided with a list of appropriate inputs corresponding to the Capped conversion. At step 802 the list of Capped inputs includes: Ratio, Begins, Conversion Cap, Exchangeable Type, Cash and Ends. Upon selection of Date Schedule, at step 803, the user preferably is provided with a list of appropriate inputs corresponding to the Date Schedule. The list of Date Schedule inputs includes: Date Stock Ratio Cash. Upon selection of the type of instrument at step 805, the user preferably is provided with a list of appropriate inputs corresponding to the Types of Instrument (e.g., PRIDES, PRIZES, etc.). The list of PRIDES inputs includes: Minimum Ratio, Optional Begins, Maximum Ratio, Exchangeable Type, Minimum Cash and Maximum Cash. Upon selection of PRIDES, at step 806, the user preferably is provided with a list of appropriate inputs corresponding to the Ratio. The list of Ratio inputs includes: Ratio, Begins, Conversion Cap, Exchangeable Type, Cash and Ends. The list of Schedule inputs may include: Date Stock Ratio Cash. The actual Conversion input values may be entered using an input device including an alpha-numerical key pad. Alternatively a drop-down menu presents input options for a user to select a desired input.

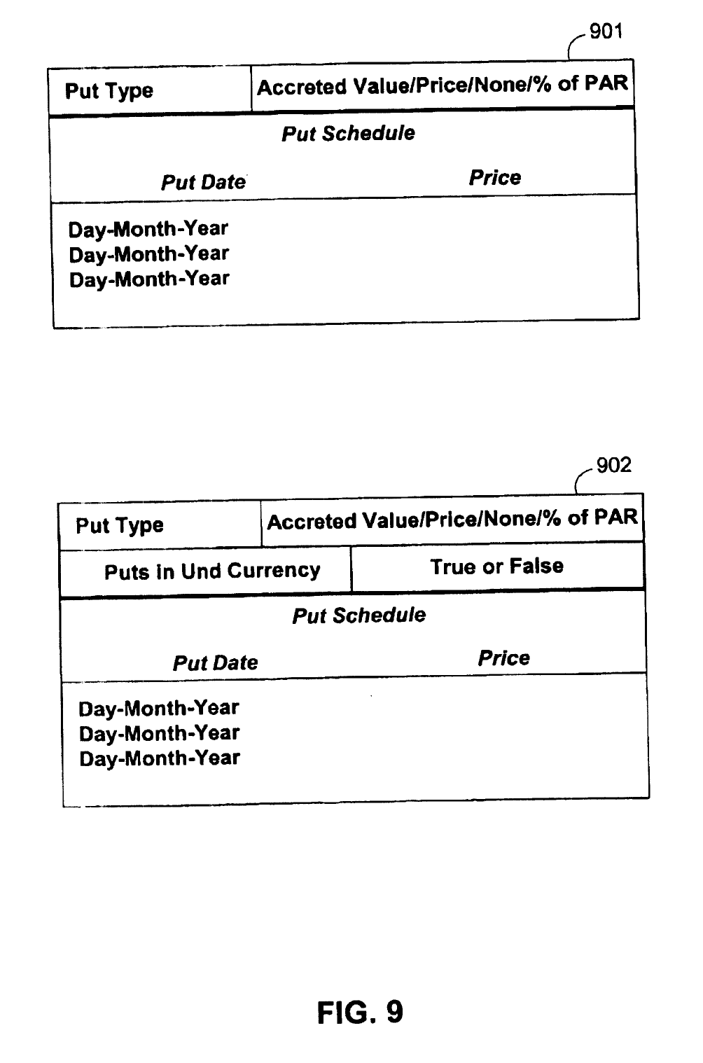

FIG. 9 shows preferred screen shots and flow of information in a system 900 for the Holder's Put Object of this invention. A creator who creates, simulates or generates a financial instrument with a Holder's Put Object at step 202 in FIG. 2, an issuer who issues a financial instrument with a Holder's Put Object at step 304 in FIG. 3, or a user who services or maintains a financial instrument using a Holder's Put Object at step 404 in FIG. 4, selects from various Holder's Put features. Holder's Put features include: Put Type 901 and Put Type with Puts in Under Currency (“Und Currency”) 902. Upon selection of Put Type (i.e., Accreted, Price, % of Par, or None), at step 901, the user preferably is provided with a Put Schedule, including a list of appropriate inputs corresponding to the Put Schedule. The Put Schedule inputs include: Put Date and Price. Upon selection of Put Type with Puts in Under Currency, at step 902, the user preferably is provided with a true/false option for selecting Puts in Und Currency at step 902. Upon the selection of true or false for Puts in Und Currency, the user preferably is provided with a Put Schedule, including a list of appropriate inputs corresponding to the Put Schedule. The Put Schedule inputs may include: Put Date and Price. The actual Conversion input values may be entered using an input device including an alpha-numerical key pad. Alternatively a drop-down menu may present input options for a user to select a desired input.

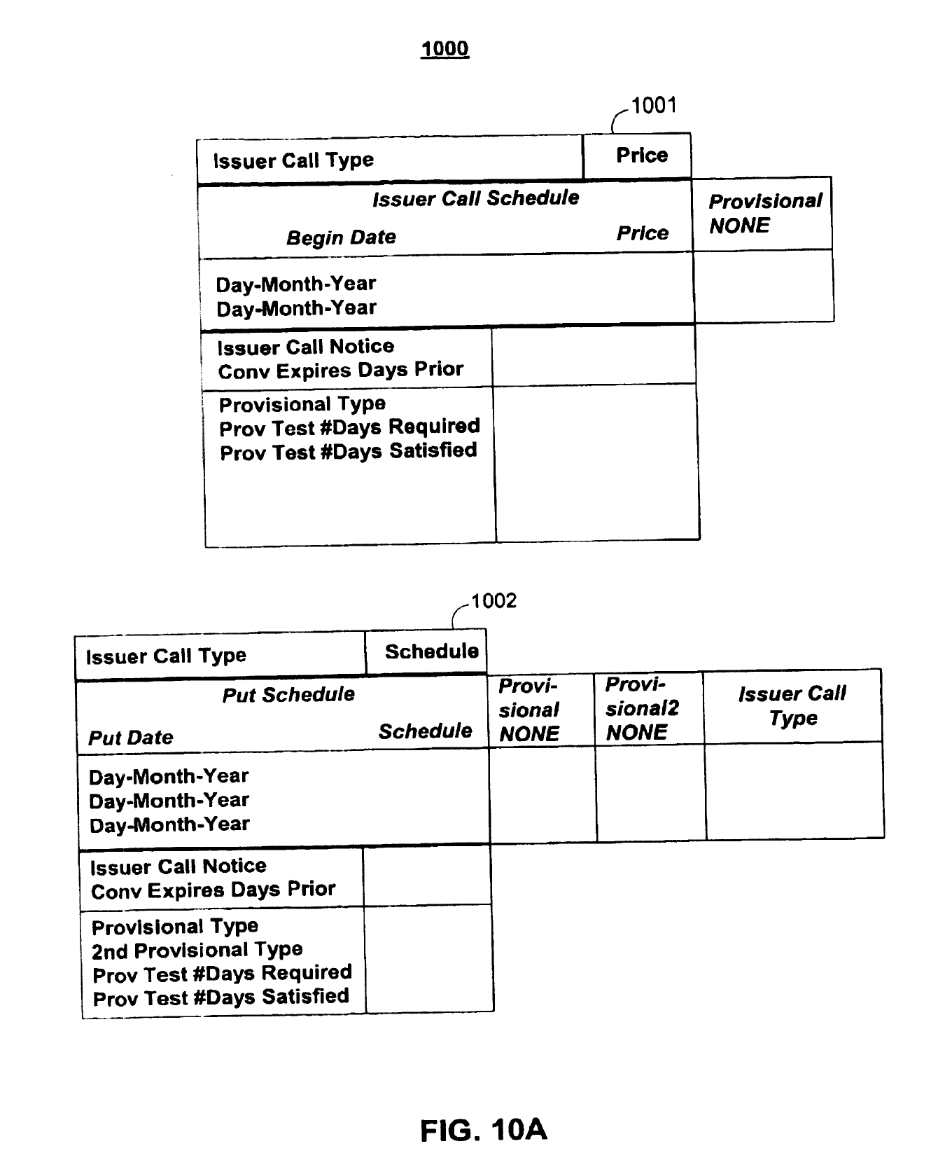

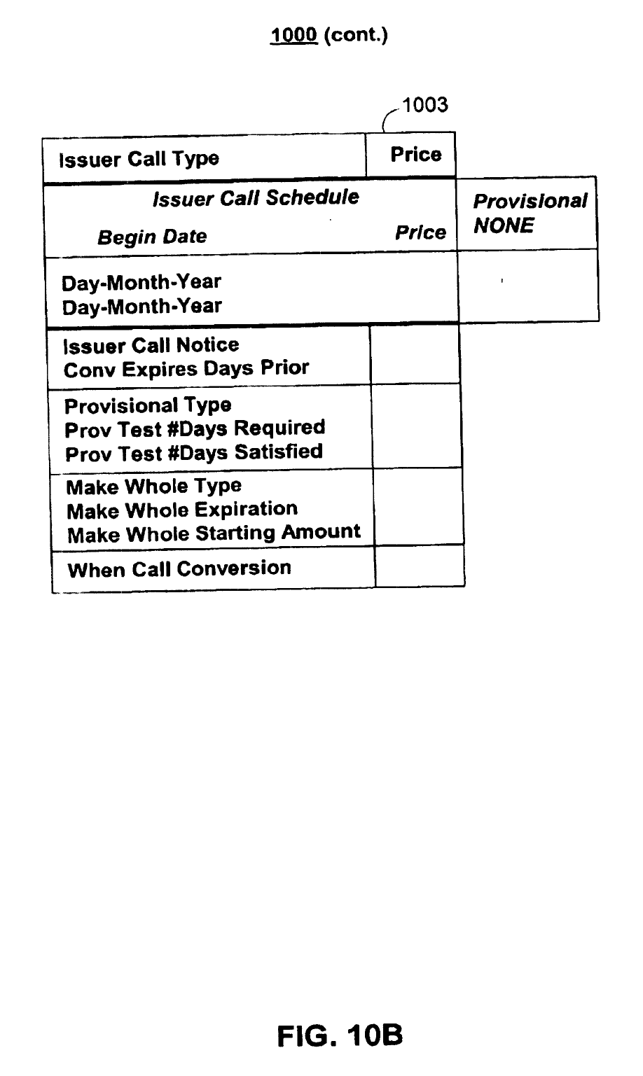

FIG. 10 shows preferred screen shots and flow of information in a system 1000 for the Issuer Call Term Object of this invention. A creator who creates, simulates or generates a financial instrument with an Issuer Call Term Object at step 202 in FIG. 2, an issuer who issues a financial instrument with an Issuer Call Term Object at step 304 in FIG. 3, or a user who services or maintains a financial instrument using an Issuer Call Term Object at step 404 in FIG. 4, may select from a list of Issuer Call Terms features. Issuer Call Terms features include: None, Price, Accreted Value, Contingent Principal Value (“CPV”), or % of Par. If a user declines to select an issuer call price (i.e., None), at step 1001, the user preferably is provided with a Issuer Call Schedule, including a list of input options such as: Issuer Call Notice, Conversion Expires Days Prior, Provisional Type, Provisional Test # Days Required or Provisional Test # Days Satisfied. Upon selection of Issuer Call type (i.e., Price, CPV, Accreted Value or % of Par), at step 1002, the user preferably is provided with a Issuer Call Schedule, including a list of input options such as: Issuer Call Notice, Conversion Expires Days Prior, Provisional Type, Provisional Test # Days Required, or Provisional Test # Days Satisfied. The actual Issuer Call Term input values may be entered using an input device including an alpha-numerical key pad. Alternatively a drop-down menu may present input options for a user to select a desired input.

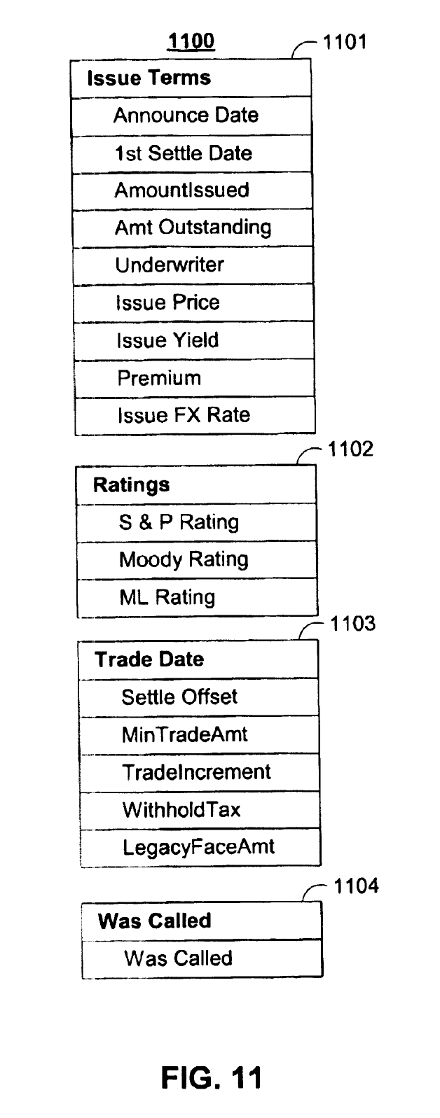

FIG. 11 shows preferred screen shots and flow of information in a system 1100 for the Issue Term Object of this invention. A creator who creates, simulates or generates a financial instrument with an Issue Terms Object at 202 in FIG. 2, an issuer who issues a financial instrument with an Issue Term Object at step 304 in FIG. 3, or a user who services or maintains a financial instrument using an Issue Terms Object at step 404 in FIG. 4 may select from a list of Issue Terms inputs. Issue Terms inputs may include: Issue Terms 1101, Ratings 1102, Trade Date 1103 and Was Called 1104. Upon selection of Issue Terms 1101, the user preferably is provided with a list of appropriate inputs corresponding to the Issue Terms. The list of Issue Terms may include: Announce Date, 1^{st} Settle Date, Amount Issued, Amount Outstanding, Underwriter, Issuer Price, Issue Yield, Premium, and Issue FX Rate. Upon selection of Ratings, at step 1102, the user preferably is provided with a list of appropriate inputs corresponding to the Ratings. The list of Rating 1102 inputs include: S&P Ratings, Moody Ratings and ML Ratings. Upon selection of Trade Date, at step 1103, the user preferably is provided with a list of appropriate inputs corresponding to the Trade Date. The list of inputs, at step 1103, may include: Settle Offset, Minimum Trade Amount, Trade Increment, Withhold Tax and Legacy Face Amount. Upon selection of Was Called, at step 1104, the user preferably is provided with a true/false option for selecting Was Called. The actual Conversion input values may be entered using an input device including an alpha-numerical key pad. Alternatively a drop-down menu may present input options for a user to select a desired input.

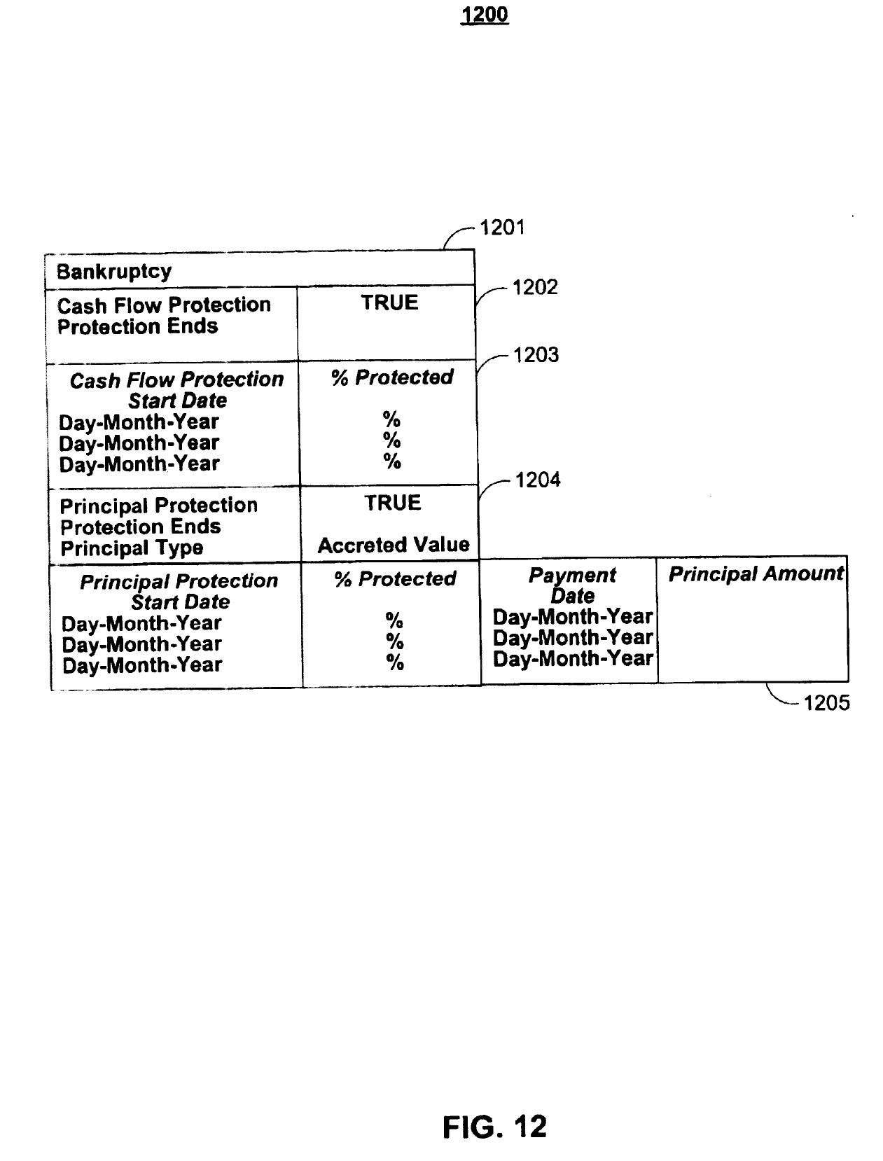

FIG. 12 shows preferred screen shots and flow of information in a system 1200 for the Bankruptcy Object of this invention. A creator who creates, simulates or generates a financial instrument with a Issue Terms Object at 202 in FIG. 2, an issuer who issues a financial instrument with a Bankruptcy Object at step 304 in FIG. 3, or a user who services or maintains a financial instrument using a Bankruptcy Object at step 404 in FIG. 4, may select from a list of Bankruptcy features. Bankruptcy inputs may include: Cash Flow Protection 1202, Cash Flow Protection Start Date and % Protected 1203, Principal Protection 1204, and Principal Protection Start Date and % Protected 1205. Upon selection of Cash Flow Protection 1202, the user preferably is provided with True or False option. More particularly, a true or false entry is selected from a pull-down menu for specific result outputs. Upon selection of “True” at step 1202, the user preferably is provided with Cash Flow Protection Start Date and % Protected 1203. At step 1203, the user preferably is provided an input cell for entry of cash flow start dates and % protected. At Principal Protection step 1204, the user preferably is provided with True or False option. More particularly, a true or false entry is selected from a pull-down menu for specific result outputs. Upon selection of “True” at step 1204, the user preferably is provided with Principal Protection Start Date, and % protected, at step 1205. The actual Bankruptcy input values may be entered using an input device including an alpha-numerical key pad. Alternatively a drop-down menu may present input options for a user to select a desired input.

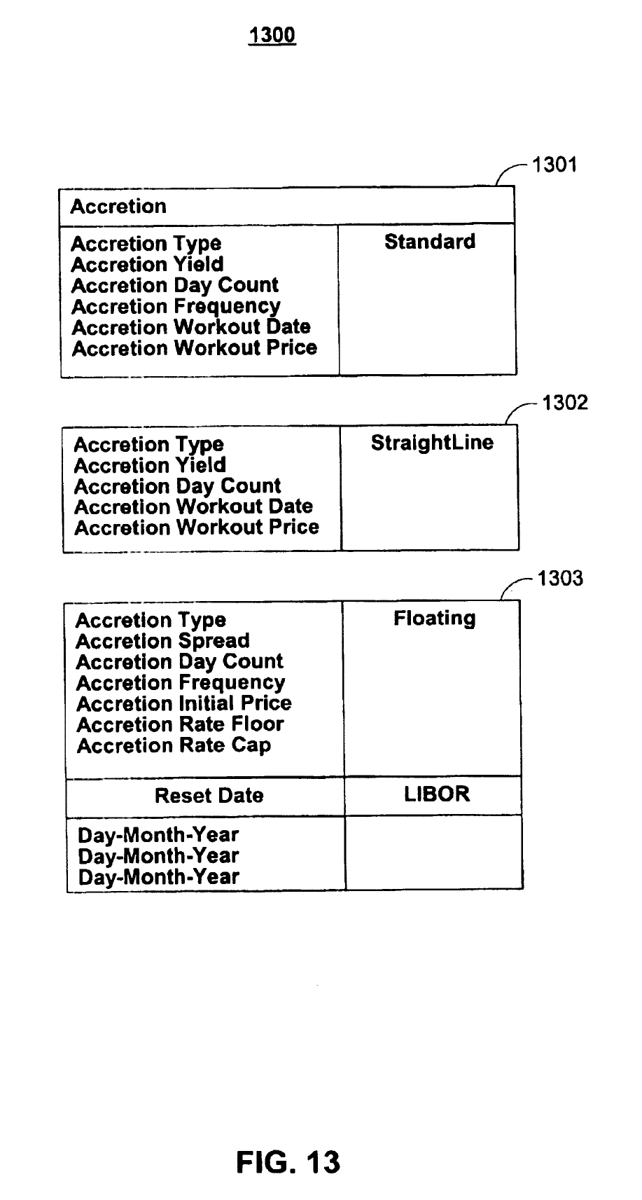

FIG. 13 shows preferred screen shots and flow of information in a system 1300 for the Accretion Object of this invention. A creator who creates, simulates or generates a financial instrument with an Accretion Object at 202 in FIG. 2, an issuer who issues a financial instrument with an Accretion Object at step 304 in FIG. 3, or a user who services or maintains a financial instrument using an Accretion Object at step 404 in FIG. 4, may select from a list of Accretion features. Upon selection of Accreted Value 1301, 1302, and 1303, the user preferably is provided with a drop down menu with options that preferably include: Standard 1301, Straight-line 1302, and Floating 1303. Upon selection of Standard at step 1301, Straight-line at step 1302, and Floating at 1303, the user preferably is provided with a list of appropriate inputs corresponding to the accretion type. That is, at step 1301, the user preferably is provided with inputs for accretion yield, accretion day count, accretion frequency, accretion workout date, and accretion workout price. At step 1302, the user preferably is provided with inputs for accretion yield, accretion day count, accretion workout date, and accretion workout price. At step 1303, the user preferably is provided with inputs for accretion spread, accretion day count, accretion frequency, accretion initial price, accretion rate floor, accretion rate cap, reset date and LIBOR. The actual Accretion input values may be entered using an input device including an alpha-numerical key pad. Alternatively a drop-down menu may present input options for a user to select a desired input.

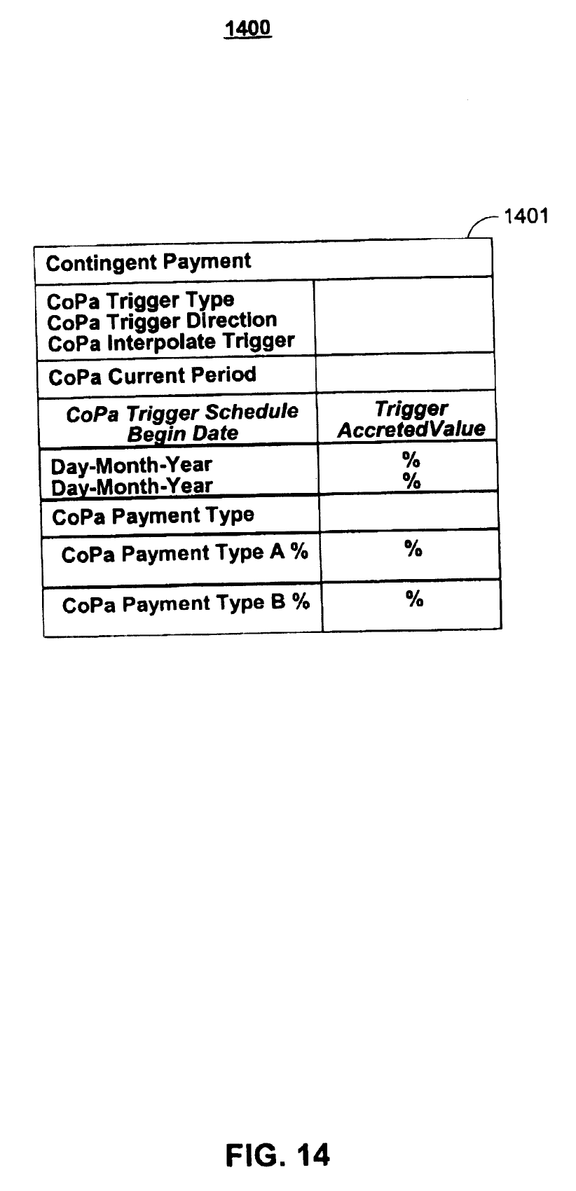

FIG. 14 shows preferred screen shots and flow of information in a system 1400 for the Contingent Payment (“CoPa”) Object of this invention. A creator who creates, simulates or generates a financial instrument with a Contingent Payment Object at 202 in FIG. 2, an issuer who issues a financial instrument with a Contingent Payment Object at step 304 in FIG. 3, or a user who services or maintains a financial instrument using a Contingent Payment Object at step 404 in FIG. 4, may select from a list of Contingent Payment Object features, at step 1401. Contingent Payment features may include: CoPa Trigger Type, CoPa Trigger Direction, CoPa Interpolate Trigger, CoPa Current Period, CoPa Payment Type, CoPa Payment Type A, and CoPa Payment Type B. Contingent payment triggers may be specified using provisional call trigger types, and contingencies may be satisfied either above or below the trigger. Trigger levels may be constant or interpolated. Upon selection of CoPa Payment Type, the user preferably is provided with a list of appropriate inputs corresponding to the CoPa Payment Type. The list of CoPa Payment Type may include: Type A, Type B, Max A and B, Min A and B, or Sum A and B. The user may also select from a list of appropriate inputs corresponding payment calculation. The list of payment calculation choices may include: Under Dividends, Parity, Market Price, and Accreted Value. The actual Contingent Payment input values may be entered using an input device including an alpha-numerical key pad. Alternatively a drop-down menu may present input options for a user to select a desired input.

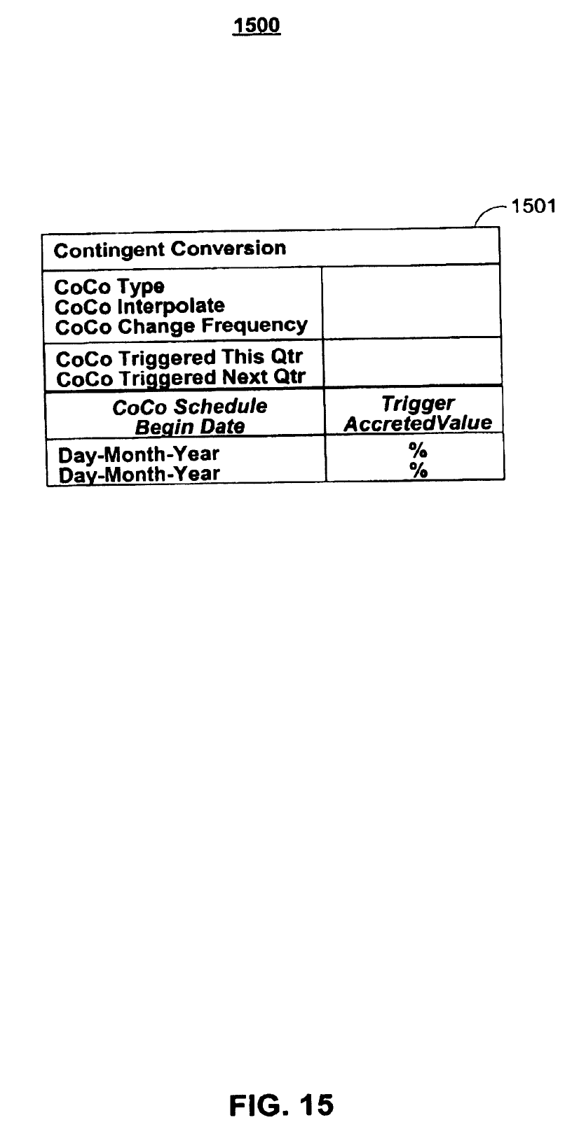

FIG. 15 shows preferred screen shots and flow of information in a system 1500 for the Contingent Conversion (“CoCo”) Object of this invention. A creator who creates, simulates or generates a financial instrument with a Contingent Conversion Object at 202 in FIG. 2, an issuer who issues a financial instrument with a Contingent Conversion Object at step 304 in FIG. 3, or a user who services or maintains a financial instrument using a Contingent Conversion Object at step 404 in FIG. 4, may select from a list of Contingent Conversion features, at step 1501. Contingent Conversion features may include: CoCo Trigger Type, CoCa Interpolate Trigger, CoCo Change Frequency, CoCo Triggered This Quarter, CoCo Triggered Next Quarter. Contingent conversion triggers may be specified using provisional call trigger types, and trigger levels may be constant or interpolated.

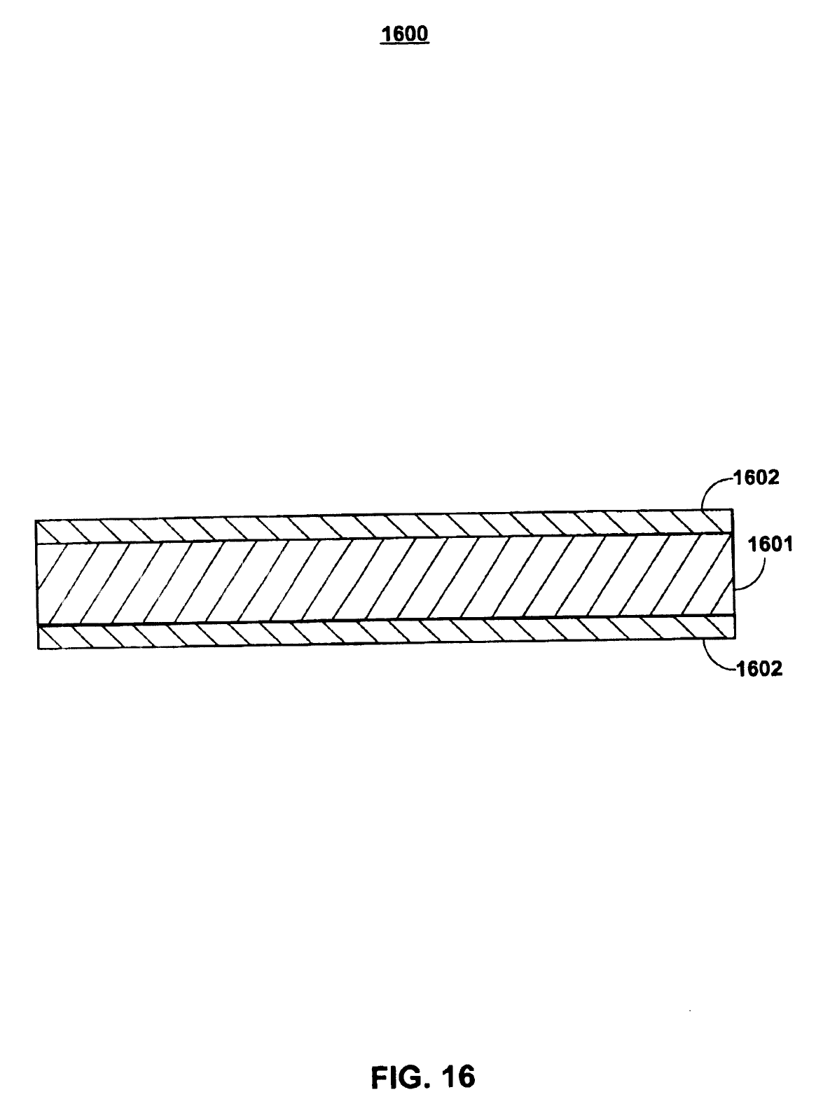

FIG. 16 presents a cross section of a magnetic data storage medium 1600 which can be encoded with a machine executable program that can be carried out by a system such as system 100 of FIG. 1. Medium 1600 can be floppy diskette or hard disk, having a suitable substrate 1601, which may be conventional, and a suitable coating 1602, which may be conventional, on one or both sides, containing magnetic domains (not visible) whose polarity or orientation can be altered magnetically. Medium 1600 may also have an opening (not shown) for receiving the spindle of a disk drive or other data storage device.

The magnetic domains of coating 1602 of medium 1600 are polarized or oriented so as to encode, in manner which may be conventional, a machine-executable program such as that described above in connection with FIGS. 2-4, for execution by a system such as system 100 of FIG. 1.

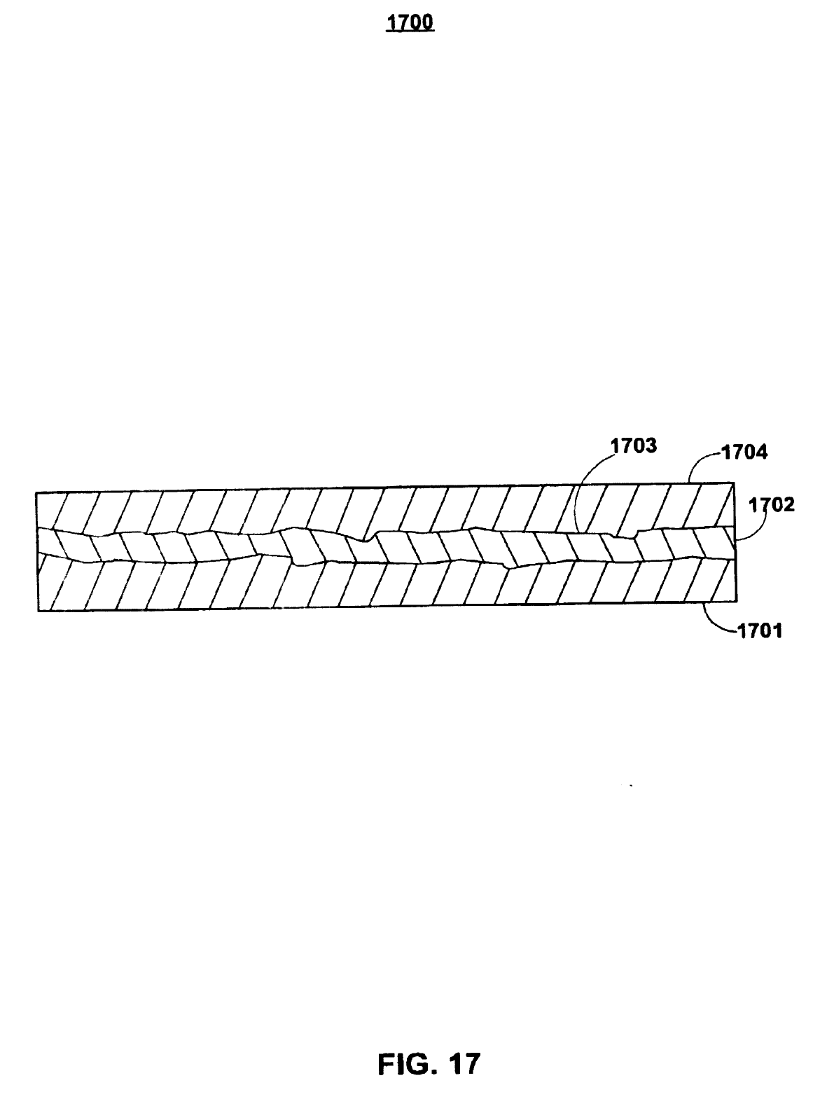

FIG. 17 shows a cross section of an optically-readable data storage medium 1700 which also can be encoded with such a machine-executable program, which can be carried out by a system such as system 100 of FIG. 1. Medium 1700 can be a conventional compact disk read only memory (CD-ROM or DVD-ROM) or a re-writable medium such as a CD-R, CD-RW, DVD-R or DVD-RAM disk or a magneto-optical disk which is optically readable and magneto-optically writeable. Medium 1700 preferably has a suitable substrate 1701, which may be conventional, and a suitable coating 1702, which may be conventional, usually on one side of substrate 1701.

In the case of a CD-ROM, CD-R, CD-RW, DVD-ROM, DVD-R, and DVD-RAM as is well known, coating 1702 is reflective and is impressed with a plurality of pits 1703 to encode the machine-executable program. The arrangement of pits is read by reflecting laser light off the surface of coating 1702. A protective coating 1704, which preferably is substantially transparent, is provided on top of coating 1702.

In the case of magneto-optical disk, as is well known, coating 1702 has no pits 1703, but has a plurality of magnetic domains whose polarity or orientation can be changed magnetically when heated above a certain temperature, as by a laser (not shown). The orientation of the domains can be read by measuring the polarization of laser light reflected from coating 1702. The arrangement of the domains encodes the program as described above.

Thus, a system and method for creating, testing, evaluating, issuing, offering, selling, servicing and maintaining convertible or exchangeable financial instruments, which provides the user with the flexibility to modify inputs objects, features of said objects and input values, allows the a user to bring new financial instruments to the market in both an cost effective and time efficient manner.

What is claimed is:

1. A method for creating a financial instrument, said method comprising:
making a selection of at least one modifiable object from a given list of objects for said financial instrument, said at least one modifiable object having at least one modifiable feature;
attributing a modifiable input value corresponding to said at least one modifiable feature of each said at least one modifiable object;
processing said input value;
storing said financial instrument.

2. The method of claim 1, wherein said making a selection of at least one modifiable object comprises at least one of:
(a) selecting said at least one modifiable object,
(b) de-selecting said at least one modifiable object, and
(c) re-selecting said at least one modifiable object.

3. The method of claim 1, wherein said making a selection of at least one modifiable object comprises at least one of:
(a) selecting a call delay object, and
(b) selecting a convertible bond option object.

4. The method of claim 1, further comprising using a short-cut to create said modifiable object.

5. The method of claim 4, wherein said using a short-cut comprises at least one of:
(a) using number of shares in place of a conversion object,
(b) using maturity date in place of a redemption object, and
(c) using repurchase spread in place of a convertible or exchangeable bond object.

6. The method of claim 1, further comprising compartmentalizing said input value.

7. The method of claim 1, further comprising preparing a risk analysis.

8. The method of claim 7, wherein said preparing a risk analysis further comprises processing said modifiable object through said risk analysis system.

9. The method of claim 1, further comprising attributing a number of underlying references for said financial instrument.

10. The method of claim 9, wherein said attributing a number of underlying references for said financial instrument comprises at least one of:
(a) attributing a constant number of said underlying references to each of said financial instrument, and
(b) attributing a variable number of said underlying references to each of said financial instrument.

11. The method of claim 1, wherein said storing said financial instrument comprises at least one of:
(a) storing said financial instrument as e-mail,
(b) storing said financial instrument to a hard drive,
(c) storing said financial instrument to a floppy disk,
(d) printing said financial instrument as a hard copy,
(e) storing on a CD, and
(f) storing on a DVD.

12. The method of claim 1, wherein said attributing a modifiable input value corresponding to said at least one modifiable feature of each said at least one modifiable object comprises using an alpha-numeric keyboard.

13. The method of claim 1, wherein said making a selection of at least one modifiable object comprises selecting at least one of:
(A) a redemption object,
(B) a cash flow object,
(C) a conversion object,
(D) an issuer call term object,
(E) a holder's put object,
(F) a issue term object,
(G) an model parameter object,
(H) a credit object,
(I) a bankruptcy object,
(J) an accretion object,
(K) a contingent payment object, and
(L) a contingent conversion object.

14. The method of claim 13, wherein said (A) redemption object comprises selecting at least one of:
(a) an amount feature,
(b) a contingent principal value feature,
(c) a mandatory feature,
(d) a par feature,
(e) a local currency feature,
(f) a percent of par feature, and
(g) a perpetual feature.

15. The method of claim 13, wherein said (B) cash flow object comprises selecting at least one of:
(a) an annual amount feature,
(b) an annual rate feature,
(c) an arbitrary schedule feature,
(d) a floating rate feature,
(e) a step-up schedule feature, and
(f) a zero feature.

16. The method of claim 13, wherein said (C) conversion object comprises selecting at least one of:
(a) a capped feature,
(b) a date schedule feature,
(c) a type of instrument feature,
(d) a ratio feature,
(e) a schedule feature, and
(f) a none feature.

17. The method of claim 13, wherein said (D) issuer call term object comprises selecting at least one of:
(a) a price feature,
(b) an accreted value feature,
(c) a contingent principal value feature,
(d) a percent of par feature, and
(e) a none feature.

18. The method of claim 13, wherein said (E) holder's put object comprises selecting at least one of:
(a) a put type feature, and
(b) a put type with puts in under currency feature.

19. The method of claim 13, wherein said (F) issue term object comprises selecting at least one of:
(a) an accreted value feature, and
(b) a ratings feature,
(c) a trade date feature, and
(d) a was called feature.

20. The method of claim 13, wherein said (G) model parameter object comprises selecting at least one of:
(a) an override model default feature,
(b) a for volatility feature, and
(c) a credit feature.

21. The method of claim 13, wherein said (I) bankruptcy object comprises selecting at least one of:
(a) a cash flow protection feature, and
(b) a principal protection feature.

22. The method of claim 13, wherein said (J) Accretion object comprises selecting at least one of:
(a) a standard accreted value feature,
(b) a straight-line accreted value feature, and
(c) a floating rate accreted value feature.

23. The method of claim 13, wherein said (K) contingent payment object comprises selecting at least one of:
(a) a trigger type feature,
(b) a trigger direction feature,
(c) a interpolate trigger feature,
(d) a current period feature, and
(e) a payment type feature.

24. The method of claim 13, wherein said (L) contingent conversion object comprises selecting at least one of:
(a) a trigger type feature,
(b) a interpolate trigger feature,
(c) a change frequency feature, and
(d) a trigger period feature.

25. A method for issuing a flexible financial instrument, said method comprising:
making a selection of at least one modifiable object from a given list of objects for said financial instrument, said at least one modifiable object having at least one modifiable feature;
attributing a modifiable input value corresponding to said at least one modifiable feature of each said at least one modifiable object;
processing said input value;
issuing said financial instrument.

26. The method of claim 25, wherein said making a selection of at least one modifiable object comprises at least one of:
(a) selecting said at least one modifiable object,
(b) de-selecting said at least one modifiable object, and
(c) re-selecting said at least one modifiable object.

27. The method of claim 25, wherein said making a selection of at least one modifiable object comprises at least one of:
(a) selecting a call delay object, and
(b) selecting a convertible bond option object.

28. The method of claim 25, further comprising compartmentalizing said input value.

29. The method of claim 25, further comprising evaluating said financial instrument prior to issuance.

30. The method of claim 25, further comprising attributing a number of underlying references for said financial instrument.

31. The method of claim 30, wherein said attributing a number of underlying references for said financial instrument comprises at least one of:
(a) attributing a constant number of said underlying references to each of said financial instrument, and
(b) attributing a variable number of said underlying references to each of said financial instrument.

32. The method of claim 25, wherein said attributing a modifiable input value corresponding to said at least one modifiable feature of each said at least one modifiable object comprises using an alpha-numeric keyboard.

33. The method of claim 25, wherein said selecting at least one modifiable object comprises selecting at least one of:
(A) a redemption object,
(B) a cash flow object,
(C) a conversion object,
(D) an issuer call term object,
(E) a holder's put object,
(F) a issue term object,
(G) an model parameter object,
(H) a credit object,
(I) a bankruptcy object,
(J) an accretion object,
(K) a contingent payment object, and
(L) a contingent conversion object.

34. The method of claim 33, wherein said (A) redemption object comprises selecting at least one of:
(a) an amount feature,
(b) a contingent principal value feature,
(c) a mandatory feature,
(d) a par feature,
(e) a local currency feature,
(f) a percent of par feature, and
(g) a perpetual feature.

35. The method of claim 33, wherein said (B) cash flow object comprises selecting at least one of:
(a) an annual amount feature,
(b) an annual rate feature,
(c) an arbitrary schedule feature,
(d) a floating rate feature,
(e) a step-up schedule feature, and
(f) a zero feature.

36. The method of claim 33, wherein said (C) conversion object comprises selecting at least one of:
(a) a capped feature,
(b) a date schedule feature,
(c) a type of instrument feature,
(d) a ratio feature,
(e) a schedule feature, and
(f) a none feature.

37. The method of claim 33, wherein said (D) issuer call term object comprises selecting at least one of:
(a) a price feature,
(b) an accreted value feature,
(c) a contingent principal value feature,
(d) a percent of par feature, and
(e) a none feature.

38. The method of claim 33, wherein said (E) holder's put object comprises selecting at least one of:
(a) a put type feature, and
(b) a put type with puts in under currency feature.

39. The method of claim 33, wherein said (F) issue term object comprises selecting at least one of:
(a) an accreted value feature, and
(b) a ratings feature,
(c) a trade date feature, and
(d) a was called feature.

40. The method of claim 33, wherein said (G) model parameter object comprises selecting at least one of:
(a) an override model default feature,
(b) a for volatility feature, and
(c) a credit feature.

41. The method of claim 33, wherein said (I) bankruptcy object comprises selecting at least one of:
(a) a cash flow protection feature, and
(b) a principal protection feature.

42. The method of claim 33, wherein said (J) Accretion object comprises selecting at least one of:
(a) a standard accreted value feature,
(b) a straight-line accreted value feature, and
(c) a floating rate accreted value feature.

43. The method of claim 33, wherein said (K) contingent payment object comprises selecting at least one of:
(a) a trigger type feature,
(b) a trigger direction feature,
(c) a interpolate trigger feature,
(d) a current period feature, and
(e) a payment type feature.

44. The method of claim 33, wherein said (L) contingent conversion object comprises selecting at least one of:
(a) a trigger type feature,
(b) a interpolate trigger feature,
(c) a change frequency feature, and
(d) a trigger period feature.

45. A method for servicing a flexible financial instrument, said method comprising:
making a selection of at least one modifiable object from a given list of objects for said financial instrument, said at least one modifiable object having at least one modifiable feature;
attributing a modifiable input value corresponding to said at least one modifiable feature of each said at least one modifiable object;
processing said input value;
storing the output data;
continuing evaluation and management of said financial instrument.

46. The method of claim 45, wherein said making a selection of at least one modifiable object comprises at least one of:
(a) selecting said at least one modifiable object,
(b) de-selecting said at least one modifiable object, and
(c) re-selecting said at least one modifiable object.

47. The method of claim 45, wherein said making a selection of at least one modifiable object comprises at least one of:
(a) selecting a call delay object, and
(b) selecting a convertible bond option object.

48. The method of claim 45, wherein said continuing evaluation and management of said financial instrument comprises re-calling, from a rules engine, an already created and issued financial instrument.

49. The method of claim 45, further comprising attributing a number of underlying references for said financial instrument.

50. The method of claim 49, wherein said attributing a number of underlying references for said financial instrument comprises at least one of:
(a) attributing a constant number of said underlying references to each of said financial instrument, and
(b) attributing a variable number of said underlying references to each of said financial instrument.

51. The method of claim 45, wherein said attributing a modifiable input value corresponding to said at least one modifiable feature of each said at least one modifiable object comprises using an alpha-numeric keyboard.

52. The method of claim 45, wherein said selecting at least one modifiable object comprises selecting at least one of:
(A) a redemption object,
(B) a cash flow object,
(C) a conversion object,
(D) an issuer call term object,
(E) a holder's put object,
(F) a issue term object,
(G) an model parameter object,
(H) an tranche object
(I) a notes object,
(J) a credit object,
(K) a bankruptcy object,
(L) an accretion object,
(M) a contingent payment object, and
(N) a contingent conversion object.

53. The method of claim 52, wherein said (A) redemption object comprises selecting at least one of:
(a) an amount feature,
(b) a contingent principal value feature,
(c) a mandatory feature,
(d) a par feature,
(e) a local currency feature,
(f) a percent of par feature, and
(g) a perpetual feature.

54. The method of claim 52, wherein said (B) cash flow object comprises selecting at least one of:
(a) an annual amount feature,
(b) an annual rate feature,
(c) an arbitrary schedule feature,
(d) a floating rate feature,
(e) a step-up schedule feature, and
(f) a zero feature.

55. The method of claim 52, wherein said (C) conversion object comprises selecting at least one of:
(a) a capped feature,
(b) a date schedule feature,
(c) a type of instrument feature,
(d) a ratio feature,
(e) a schedule feature, and
(f) a none feature.

56. The method of claim 52, wherein said (D) call term object comprises selecting at least one of:
(a) a price feature,
(b) an accreted value feature,
(c) a contingent principal value feature,
(d) a percent of par feature, and
(e) a none feature.

57. The method of claim 52, wherein said (E) holder's put object comprises selecting at least one of:
(a) a put type feature, and
(b) a put type with puts in under currency feature.

58. The method of claim 52, wherein said (F) issue term object comprises selecting at least one of:
(a) an accreted value feature, and
(b) a ratings feature,
(c) a trade date feature, and
(d) a was called feature.

59. The method of claim 52, wherein said (G) model parameter object comprises selecting at least one of:
(a) an override model default feature,
(b) a for volatility feature, and
(c) a credit feature.

60. The method of claim 33, wherein said (K) bankruptcy object comprises selecting at least one of:
(a) a cash flow protection feature, and
(b) a principal protection feature.

61. The method of claim 52, wherein said (L) accretion object comprises selecting at least one of:
(a) a standard accreted value feature,
(b) a straight-line accreted value feature, and
(c) a floating rate accreted value feature.

62. The method of claim 52, wherein said (M) contingent payment object comprises selecting at least one of:
(a) a trigger type feature,
(b) a trigger direction feature,
(c) a interpolate trigger feature,
(d) a current period feature, and
(e) a payment type feature.

63. The method of claim 52, wherein said (N) contingent conversion object comprises selecting at least one of:
(a) a trigger type feature,
(b) a interpolate trigger feature,
(c) a change frequency feature, and
(d) a trigger period feature.

64. The method of claim 45, wherein said storing said financial instrument comprises at least one of:
(a) storing said financial instrument as e-mail,
(b) storing said financial instrument to a hard drive,
(c) storing said financial instrument to a floppy disk,
(d) printing said financial instrument as a hard copy,
(e) storing on a CD, and
(f) storing on a DVD.

65. A system for creating a flexible financial instrument, said system comprising:
means for making a selection of at least one modifiable object from a given list of objects for said financial instrument, said at least one modifiable object having at least one modifiable feature;
means for attributing a modifiable input value corresponding to said at least one modifiable feature of each said at least one modifiable object;
means for processing said input value;
means for storing said financial instrument.

66. The system of claim 65, wherein said means for making a selection of at least one modifiable object comprises at least one of:
(a) means for selecting said at least one modifiable object,
(b) means for de-selecting said at least one modifiable object, and
(c) means for re-selecting said at least one modifiable object.

67. The system of claim 65, wherein said means for making a selection of at least one modifiable object comprises at least one of:
(a) means for selecting a call delay object, and
(b) means for selecting a convertible bond option object.

68. The system of claim 65, further comprising means for using a short-cut to create said modifiable object.

69. The system of claim 68, wherein said means for using a short-cut comprises at least one of:
(a) means for using number of shares in place of a conversion object,
(b) means for using maturity date in place of a redemption object, and
(c) means for using repurchase spread in place of a convertible or exchangeable bond object.

70. The system of claim 65, further comprising means for compartmentalizing said input value.

71. The system of claim 65, further comprising means for preparing a risk analysis.

72. The system of claim 71, wherein said means for preparing a risk analysis further comprises means for processing said modifiable object through said risk analysis system.

73. The system of claim 65, further comprising means for attributing a number of underlying references for said financial instrument.

74. The system of claim 73, wherein said means for attributing a number of underlying references for said financial instrument comprises at least one of:
(a) means for attributing a constant number of said underlying references to each of said financial instrument, and
(b) means for attributing a variable number of said underlying references to each of said financial instrument.

75. The system of claim 65, wherein said means for storing said financial instrument comprises at least one of:
(a) means for storing said financial instrument as e-mail,
(b) means for storing said financial instrument to a hard drive,
(c) means for storing said financial instrument to a floppy disk,
(d) means for printing said financial instrument as a hard copy,
(e) means for storing on a CD, and
(f) means for storing on a DVD.

76. The system of claim 65, wherein said means for attributing a modifiable input value corresponding to said at least one modifiable feature of each said at least one modifiable object comprises means for using an alpha-numeric keyboard.

77. The system of claim 65, wherein said means for making a selection of at least one modifiable object comprises means for selecting at least one of:
(A) a redemption object,
(B) a cash flow object,
(C) a conversion object,
(D) an issuer call term object,
(E) a holder's put object,
(F) a issue term object,
(G) an model parameter object,
(H) a credit object,
(I) a bankruptcy object,
(J) an accretion object,
(K) a contingent payment object, and
(L) a contingent conversion object.

78. The system of claim 77, wherein said means for selecting (A) redemption object comprises means for selecting at least one of:
(a) an amount feature,
(b) a contingent principal value feature,
(c) a mandatory feature,
(d) a par feature,
(e) a local currency feature,
(f) a percent of par feature, and
(g) a perpetual feature.

79. The system of claim 77, wherein said means for selecting (B) cash flow object comprises means for selecting at least one of:
(a) an annual amount feature,
(b) an annual rate feature,
(c) an arbitrary schedule feature,
(d) a floating rate feature,
(e) a step-up schedule feature, and
(f) a zero feature.

80. The system of claim 77, wherein said means for selecting (C) conversion object comprises means for selecting at least one of:
(a) a capped feature,
(b) a date schedule feature,
(c) a type of instrument feature,
(d) a ratio feature,
(e) a schedule feature, and
(f) a none feature.

81. The system of claim 77, wherein said means for selecting (D) issuer call term object comprises means for selecting at least one of:
(a) a price feature,
(b) an accreted value feature,
(c) a contingent principal value feature,
(d) a percent of par feature, and
(e) a none feature.

82. The system of claim 77, wherein said means for selecting (E) holder's put object comprises means for selecting means for at least one of:
(a) a put type feature, and
(b) a put type with puts in under currency feature.

83. The system of claim 77, wherein said means for selecting (F) issue term object comprises means for selecting at least one of:
(a) an accreted value feature, and
(b) a ratings feature,
(c) a trade date feature, and
(d) a was called feature.

84. The system of claim 77, wherein said means for selecting (G) model parameter object comprises means for selecting at least one of:
(a) an override model default feature,
(b) a for volatility feature, and
(c) a credit feature.

85. The system of claim 77, wherein said means for means for selecting (I) bankruptcy object comprises means for selecting at least one of:
(a) a cash flow protection feature, and
(b) a principal protection feature.

86. The system of claim 77, wherein said means for selecting (J) Accretion object comprises means for selecting at least one of:
(a) a standard accreted value feature,
(b) a straight-line accreted value feature, and
(c) a floating rate accreted value feature.

87. The system of claim 77, wherein said means for selecting (K) contingent payment object comprises means for selecting at least one of:
(a) a trigger type feature,
(b) a trigger direction feature,
(c) a interpolate trigger feature,
(d) a current period feature, and
(e) a payment type feature.

88. The system of claim 77, wherein said means for selecting (L) contingent conversion object comprises means for selecting at least one of:
(a) a trigger type feature,
(b) a interpolate trigger feature,
(c) a change frequency feature, and
(d) a trigger period feature.

89. A system for issuing a flexible financial instrument, said system comprising:
means for making a selection of at least one modifiable object from a given list of objects for said financial instrument, said at least one modifiable object having at least one modifiable feature;
means for attributing a modifiable input value corresponding to said at least one modifiable feature of each said at least one modifiable object;
means for processing said input value;
means for issuing said financial instrument.

90. The system of claim 89, wherein said means for making a selection of at least one modifiable object comprises at least one of:
(a) means for selecting said at least one modifiable object,
(b) means for de-selecting said at least one modifiable object, and
(c) means for re-selecting said at least one modifiable object.

91. The system of claim 89, wherein said means for making a selection of at least one modifiable object comprises at least one of:
(a) means for selecting a call delay object, and
(b) means for selecting a convertible bond option object.

92. The system of claim 89, further comprising means for compartmentalizing said input value.

93. The system of claim 89, further comprising means for evaluating said financial instrument prior to issuance.

94. The system of claim 89, further comprising means for attributing a number of underlying references for said financial instrument.

95. The system of claim 94, wherein said means for attributing a number of underlying references for said financial instrument comprises at least one of:
(a) means for attributing a constant number of said underlying references to each of said financial instrument, and
(b) means for attributing a variable number of said underlying references to each of said financial instrument.

96. The system of claim 89, wherein said means for attributing a modifiable input value corresponding to said at least one modifiable feature of each said at least one modifiable object comprises means for using an alpha-numeric keyboard.

97. The system of claim 89, wherein said means for selecting at least one modifiable object comprises means for selecting at least one of:
(A) a redemption object,
(B) a cash flow object,
(C) a conversion object,
(D) an issuer call term object,
(E) a holder's put object,
(F) a issue term object,
(G) an model parameter object,
(H) a credit object,
(I) a bankruptcy object,
(J) an accretion object,
(K) a contingent payment object, and
(L) a contingent conversion object.

98. The system of claim 97, wherein said means for selecting (A) redemption object comprises means for selecting at least one of:
(a) an amount feature,
(b) a contingent principal value feature,
(c) a mandatory feature,
(d) a par feature,
(e) a local currency feature,
(f) a percent of par feature, and
(g) a perpetual feature.

99. The system of claim 97, wherein said means for selecting (B) cash flow object comprises means for selecting at least one of:
(a) an annual amount feature,
(b) an annual rate feature,
(c) an arbitrary schedule feature,
(d) a floating rate feature,
(e) a step-up schedule feature, and
(f) a zero feature.

100. The system of claim 97, wherein said means for selecting (C) conversion object comprises means for selecting at least one of:
(a) a capped feature,
(b) a date schedule feature,
(c) a type of instrument feature,
(d) a ratio feature,
(e) a schedule feature, and
(f) a none feature.

101. The system of claim 97, wherein said means for selecting (D) issuer call term object comprises means for selecting at least one of:
(a) a price feature,
(b) an accreted value feature,
(c) a contingent principal value feature,
(d) a percent of par feature, and
(e) a none feature.

102. The system of claim 97, wherein said means for selecting (E) holder's put object comprises means for selecting at least one of:
(a) a put type feature, and
(b) a put type with puts in under currency feature.

103. The system of claim 97, wherein said means for selecting (F) issue term object comprises means for selecting at least one of:
(a) an accreted value feature, and
(b) a ratings feature,
(c) a trade date feature, and
(d) a was called feature.

104. The system of claim 97, wherein said means for selecting (G) model parameter object comprises means for selecting at least one of:
(a) an override model default feature,
(b) a for volatility feature, and
(c) a credit feature.

105. The system of claim 97, wherein said means for selecting (I) bankruptcy object comprises means for selecting at least one of:
(a) a cash flow protection feature, and
(b) a principal protection feature.

106. The system of claim 97, wherein said means for selecting (J) Accretion object comprises means for selecting at least one of:
(a) a standard accreted value feature,
(b) a straight-line accreted value feature, and
(c) a floating rate accreted value feature.

107. The system of claim 97, wherein said means for selecting (K) contingent payment object comprises means for selecting at least one of:
(a) a trigger type feature,
(b) a trigger direction feature,
(c) a interpolate trigger feature,
(d) a current period feature, and
(e) a payment type feature.

108. The system of claim 97, wherein said means for selecting (L) contingent conversion object comprises means for selecting at least one of:
(a) a trigger type feature,
(b) a interpolate trigger feature,
(c) a change frequency feature, and
(d) a trigger period feature.

109. A system for servicing a flexible financial instrument, said system comprising:
means for making a selection of at least one modifiable object from a given list of objects for said financial instrument, said at least one modifiable object having at least one modifiable feature;
means for attributing a modifiable input value corresponding to said at least one modifiable feature of each said at least one modifiable object;
means for processing said input value;
means for storing the output data;
means for continuing evaluation and management of said financial instrument.

110. The system of claim 89, wherein said means for making a selection of at least one modifiable object comprises at least one of:
(a) means for selecting said at least one modifiable object,
(b) means for de-selecting said at least one modifiable object, and
(c) means for re-selecting said at least one modifiable object.

111. The system of claim 109, wherein said means for making a selection of at least one modifiable object comprises at least one of:
(a) means for selecting a call delay object, and
(b) means for selecting a convertible bond option object.

112. The system of claim 109, wherein said means for continuing evaluation and management of said financial instrument comprises means for re-calling, from a rules engine, an already created and issued financial instrument.

113. The system of claim 109, further comprising means for attributing a number of underlying references for said financial instrument.

114. The system of claim 113, wherein said means for attributing a number of underlying references for said financial instrument comprises at least one of:
(a) means for attributing a constant number of said underlying references to each of said financial instrument, and
(b) means for attributing a variable number of said underlying references to each of said financial instrument.

115. The system of claim 109, wherein said means for attributing a modifiable input value corresponding to said at least one modifiable feature of each said at least one modifiable object comprises means for using an alpha-numeric keyboard.

116. The system of claim 109, wherein said means for selecting at least one modifiable object comprises means for selecting at least one of:
(A) a redemption object,
(B) a cash flow object,
(C) a conversion object,
(D) an issuer call term object,
(E) a holder's put object,
(F) a issue term object,
(G) an model parameter object,
(H) an tranche object
(I) a notes object,
(J) a credit object,
(K) a bankruptcy object,
(L) an accretion object,
(M) a contingent payment object, and
(N) a contingent conversion object.

117. The system of claim 116, wherein said means for selecting (A) redemption object comprises means for selecting at least one of:
(a) an amount feature,
(b) a contingent principal value feature,
(c) a mandatory feature,
(d) a par feature,
(e) a local currency feature,
(f) a percent of par feature, and
(g) a perpetual feature.

118. The system of claim 116, wherein said means for selecting (B) cash flow object comprises means for selecting at least one of:
(a) an annual amount feature,
(b) an annual rate feature,
(c) an arbitrary schedule feature,
(d) a floating rate feature,
(e) a step-up schedule feature, and
(f) a zero feature.

119. The system of claim 116, wherein said means for selecting (C) conversion object comprises means for selecting at least one of:
(a) a capped feature,
(b) a date schedule feature,
(c) a type of instrument feature,
(d) a ratio feature,
(e) a schedule feature, and
(f) a none feature.

120. The system of claim 116, wherein said means for selecting (D) call term object comprises means for selecting at least one of:
(a) a price feature,
(b) an accreted value feature,
(c) a contingent principal value feature,
(d) a percent of par feature, and
(e) a none feature.

121. The system of claim 116, wherein said means for selecting (E) holder's put object comprises means for selecting at least one of:
(a) a put type feature, and
(b) a put type with puts in under currency feature.

122. The system of claim 116, wherein said means for selecting (F) issue term object comprises means for selecting at least one of:
(a) an accreted value feature, and
(b) a ratings feature,
(c) a trade date feature, and
(d) a was called feature.

123. The system of claim 116, wherein said means for selecting (G) model parameter object comprises means for selecting at least one of:
(a) an override model default feature,
(b) a for volatility feature, and
(c) a credit feature.

124. The system of claim 109, wherein said means for storing said financial instrument comprises at least one of:
(a) means for storing said financial instrument as e-mail,
(b) means for storing said financial instrument to a hard drive,
(c) means for storing said financial instrument to a floppy disk,
(d) means for printing said financial instrument as a hard copy,
(e) means for storing on a CD, and
(f) means for storing on a DVD.

125. The system of claim 116, wherein said means for selecting (K) bankruptcy object comprises means for selecting at least one of:
(a) a cash flow protection feature, and
(b) a principal protection feature.

126. The system of claim 116, wherein said means for selecting (L) accretion object comprises means for selecting at least one of:
(a) a standard accreted value feature,
(b) a straight-line accreted value feature, and
(c) a floating rate accreted value feature.

127. The system of claim 116, wherein said means for selecting (M) contingent payment object comprises means for selecting at least one of:
(a) a trigger type feature,
(b) a trigger direction feature,
(c) a interpolate trigger feature,
(d) a current period feature, and
(e) a payment type feature.

128. The system of claim 116, wherein said means for selecting (N) contingent conversion object comprises means for selecting at least one of:
(a) a trigger type feature,
(b) a interpolate trigger feature,
(c) a change frequency feature, and
(d) a trigger period feature.

129. A financial services system for creating a flexible financial instrument, said system comprising:
an object selection unit that selects at least one modifiable object from a given list of objects for said financial instrument, said at least one modifiable object having at least one modifiable feature;
an attribution unit that attributes a modifiable input value corresponding to said at least one modifiable feature of each said at least one modifiable object;
a processing unit that processes said input value;
a storage unit that stores said financial instrument.

130. The financial services system of claim 129 wherein said processing unit comprises a calculation unit for calculation of said input values.

131. A financial services system for issuing a flexible financial instrument, said system comprising:
an object selection unit that selects at least one modifiable object from a given list of objects for said financial instrument, said at least one modifiable object having at least one modifiable feature;
an attribution unit that attributes a modifiable input value corresponding to said at least one modifiable feature of each said at least one modifiable object;
a processing unit that processes said input value;
a storage unit that stores said financial instrument.

132. The financial services system of claim 131 wherein said processing unit comprises a calculation unit for calculation of said input values.

133. A financial services system for servicing a flexible financial instrument, said system comprising:
an object selection unit that selects at least one modifiable object from a given list of objects for said financial instrument, said at least one modifiable object having at least one modifiable feature;
an attribution unit that attributes a modifiable input value corresponding to said at least one modifiable feature of each said at least one modifiable object;
a processing unit that processes said input value;
a storage unit that stores said financial instrument.

134. The financial services system of claim 133 wherein said processing unit comprises a calculation unit for calculation of said input values.

135. A machine-readable data storage medium encoded with a set of machine-executable instructions for using a data processing system to perform a method for creating a flexible financial instrument, said method comprising:
making a selection of at least one modifiable object from a given list of objects for said financial instrument, said at least one modifiable object having at least one modifiable feature;
attributing a modifiable input value corresponding to said at least one modifiable feature of each said at least one modifiable object;
processing said input value;
storing said financial instrument.

136. The machine-readable data storage medium of claim 135, wherein said method further comprises:
using a short-cut to create said modifiable object.

137. The machine-readable data storage medium of claim 135, wherein said method further comprises:
compartmentalizing said input value.

138. The machine-readable data storage medium of claim 135, wherein said method further comprises:
preparing a risk analysis.

139. The machine-readable data storage medium of claim 135, wherein said method further comprises:
attributing a number of underlying references for said financial instrument.

140. The machine-readable data storage medium of any one of claims 135, 136, 137, 138 and 139, where said data storage medium is magnetic.

141. The magnetic machine-readable data storage medium of claim 140, where said data storage medium is a floppy diskette.

142. The magnetic machine-readable data storage medium of claim 140, where said data storage medium is a hard disk.

143. The machine-readable data storage medium
